(19) United States
(12) Patent Application Publication
(10) Pub. No.: US 2005/0165713 A1
(43) Pub. Date: Jul. 28, 2005

(54) Method for reorganization management in a set of indexed databases of a computer system

(75) Inventor: Bernard Lafforet, Le Plessis Trevise (FR)

Correspondence Address: STEVENS DAVIS MILLER & MOSHER, LLP, 1615 L STREET, NW, SUITE 850, WASHINGTON, DC, 20036, US

(73) Assignee: INFOTEL, Tour Gallieni 11, Bagnolet (FR)

(21) Appl. No.: 10/510,635

(22) PCT Filed: Apr. 4, 2003
(86) PCT No.: PCT/FR03/01076

(30) Foreign Application Priority Data
Apr. 8, 2002 (FR) 02/04301

(51) Int. Cl. G06F 17/30

(52) U.S. Cl. 707/1

(57) ABSTRACT

The invention concerns an offline reorganization management in a set of indexed databases, in particular of the tablespace type, of an information computer system comprising the following steps: (10): continuously maintaining a list (PRIOREORG) of objects to be reorganized in descending order of priority; (20) executing a process (IDPOR) of identification of the next object to be reorganized (POR) in the absence of any reappraisal event (RAZ) and comprising the following steps: (21) establishing a rapid reorganization planning (PRR) using the list (PRIOREORG) and residual operational time (TRR) and a selection list (SELECT) of objects (OR); (22) establishing reorganization retroactive planning with LIFO memory storage of objects extracted from the list (SELECT); (23) identifying the available processing zone (RTR) to reorganize the object (POR); (24) writing (POR) when the zone (RTR) is cleared in the absence of any event (RAZ); and re-executing the process (IDPOR).

The present invention relates to the reorganization of databases managed with the aid of a data processing system, more particularly indexed databases in which an index, usually in the form of an index table, is used to access an object searched for, such as a row of the database, for example. These databases may be very large. To give a concrete idea of this, without limiting the invention in any way, the size of these very large databases may be from a million to a few billion rows. These databases are generally stored in high capacity memories, for example disc memories, each row of data being addressed in an appropriate fashion. The considerable sizes that the databases may have often require them to be partitioned, in which case the partitions are associated specific partition indexes and/or complete database indexes.

Periodic reorganization of the database is crucial to maintaining the capacity of a database to be consulted via an online connection with a reasonable data access time, despite the delaying effect of updates to the database.

Reorganization is an essential step in the maintenance of databases (and their indexes). Reorganization is effected offline, generally during a maintenance window (batch window), and entails downloading the database, rearranging its information lines in a required order, for example alphabetical order, and then uploading the rearranged rows into the database and updating the indexes, if possible in a reorganized fashion.

Hereinafter the term “object to be reorganized” (OR) will be used interchangeably for an object of an information system liable to be reorganized, in particular the database alone, its index or indexes, the combination of the database and its index, the partitions of the database, their associated indexes (whether specific or not), and the combinations of partitions and their indexes.

Hereinafter the expressions “information data processing system” and “information system” refers to a complete data processing system (hardware and software) suitable for the management of databases and comprising at least one database. Such systems are encountered in particular in the form of internal or external online servers to which users connect to consult the corresponding database by means of requests and other data search enquiries.

The “machine” capacities of the information system (central units, where applicable networked central units) are in general divided into distinct processing regions controlled individually by a control region. Each processing region is assigned a certain number of ordered tasks (programs or subroutines to be executed) and allocated the necessary hardware resources in terms of virtual memory and peripherals (hard discs, printers, external storage media, etc.). For efficient execution and allocation of hardware and/or software resources, each processing region is if possible assigned tasks of the same type, such as, for example, for tasks generally executable in the maintenance window, known as the batch window, reorganizing files or databases (requiring much disc space) or file image copying (requiring external output peripherals, magnetic tape drives, CD-ROM readers/burners, etc.).

Database reorganization is generally necessary to prevent degraded performance of transactions (reading and/or updating) that access the databases. However, it is not possible to maintain all the objects of an information system in a state of perfect organization because:
i) reorganization consumes system time and resources (processors, random access memory and disc memory);
ii) reorganizations that are too frequent generate implementation costs greater than the overcosts generated by the operation of databases that are weakly disorganized.

A first step of the task of managing the reorganization of a set of databases consists in drawing up a reorganization schedule which is used to launch offline reorganization of the databases during the daily maintenance period of a few hours provided for the information system (known as the batch window or grouped execution window).

Software tools are known in the art for generating a reorganization schedule as a function of:
a list of objects to be reorganized,
a predetermined reorganization frequency for each object,
a level of disorganization of the objects measured by undocumented techniques.

However, none of the tools known in the art reviews the original schedule as a function of events that may occur during the execution of scheduled reorganizations.

Additionally, none of these tools claims to optimize schedule generation, in particular on the basis of the hardware and software resources available at the time and/or on the basis of reorganization and/or non-reorganization costs or as a function of instantaneous real or estimated parameters of the objects to be reorganized, such as their size, their level of disorganization, and the time to reorganize them.

An object of the invention is to manage the reorganization of a set of indexed databases of an information data processing system to improve the performance of a given configuration of the information system by continuous optimization, in particular from the point of view of the time and/or cost of reorganizing the databases (and/or their partitions) and their indexes.

To this end, the invention proposes a method of managing reorganizations in a set of indexed databases of an information data processing system adapted to “offline” reorganization in at least one reorganization processing region of the system, characterized in that it comprises the following operational phases (see FIG. 1):
(10)—Creating and maintaining by continuously updating a list PRIOREORG of objects to be organized in decreasing priority order as a function of the level of disorganization of the objects to be reorganized;
(20)—Executing a process IDPOR of identifying the first or next object to be reorganized POR with, at each event RAZR=1 internal to the system for which the selection of the first or next object to be reorganized must be reviewed, interrupting, resetting and re-executing the process IDPOR, which comprises the following steps:
(21)—Establishing a rapid reorganization schedule PRR with the aid of the list PRIOREORG and the remaining operational time TRR available in all of the reorganization regions and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
(22)—Establishing a retro-active reorganization schedule in which, for any current object OR to be reorganized extracted from the list SELECT/OR in increasing priority order to promote the processing in advance of any objects of larger sizes, there is calculated for each reorganization region the last time DDRR of the region, representing in the “Batch” window allocated to “offline” reorganization the minimum time necessary for reorganizing the current object OR, equal in the present instance to the time consumed DCRR plus the time DROR to reorganize the current object;
(23)—Identifying the processing region RTR of the current object OR by optimized matching of the processing time DRR available in said region with the processing time DROR necessary for reorganizing the object POR with minimum DRR−DDRR≦0;
(24)—Entering the current object OR as the next object to be reorganized POR in the schedule of the identified region by setting the pointer POR corresponding to the address of the current object to be reorganized and increasing the consumed time DCRR in the region by the reorganization time DROR;
(30)—Launching the reorganization of the object POR as soon as the identified reorganization processing region RTR is released in the absence of any event RAZR=1 occurring in the meantime; resetting and re-execution of the process IDPOR.

Thus the introduction into the management method of the invention of the principle of rapid reorganization scheduling PRR (requiring minimal machine time to enable frequent updating without real penalties) and the principle of continuous updating of the rapid reorganization schedule PRR takes immediately into account the evolution of the complete information system and its principal parameters (instantaneous levels of disorganization of the objects to be reorganized, extension of the reorganization time relative to the estimated time, release of a processing region, end of a reorganization task, etc.) to modify reorganization priorities and optimize the launching of reorganization.

Backing up modified files is a security imperative in the field of the operation of data processing systems, and goes hand in hand with the reorganization of files such as databases. This is because, to achieve secure data processing, some of the information systems that are used to manage a set of databases incorporate in their operating software a device for blocking the return to service of a reorganized database before a corresponding back-up copy is made.

In a first embodiment of the management method according to the invention, the optimum reorganization order is coordinated with the order of back-up copying of objects of the information system taking account of reorganizations in progress or just effected. In an advantageous variant of the method, the back-up copying order is modified by executing with the highest priority, for at least one object OR to be reorganized, the copying of said object OR as soon as possible at the end of reorganization processing.

To this end, the reorganization management method of the invention is globalized to manage reorganization and copying knowing that, for optimization purposes, the objects to be processed may be divided into partitions, down to the level of the smallest portions possible of objects to be processed by each type of process. As a result of this, the list and objects to be copied may be different from the list and objects to be reorganized.

Moreover, where copying is concerned, three types of copy are generally distinguished, namely continuous copying, also known as log copying, incremental copying, applied only to modifications made to files, and total copying, also known as image copying. In the context of the present invention, image copying is of primary concern and incremental copying of subsidiary concern.

In a similar fashion to the method of managing reorganization, the method of managing reorganization and copying comprises a phase of creating and maintaining a list PRIOCOPIE of the priority of objects to be copied (as a function of the time elapsed since the last copying of each object to be copied (OC)) and the establishing of a rapid copying schedule, given that certain objects just reorganized (OR), for example a database, are locked before they come back online by image copying; to this end, in the context of the present invention, the choice is made to give the first priority to copying these objects. This results in a twofold interaction between the rapid copying schedule PRC and the rapid reorganization schedule PRR* (similar to the rapid reorganization schedule PRR but modified to integrate the copying component), for the former (PRC) with the first priority accorded to certain copies or to all copies after reorganization and for the latter (PRR*) by extending the total reorganization time by adding to the real machine time for reorganization a waiting time (also known as wasted time) corresponding to the time to copy the objects just reorganized.

To this end, the invention proposes a global method of managing reorganizations of a set of indexed databases of an information system adapted to “offline” reorganization integrating the management of copying and comprising the following operational phases (see FIG. 2):
(40)—Creating and maintaining by continuously updating:
   a list PRIOREORG of objects to be reorganized in decreasing priority order as a function of the level of disorganization of the objects to be reorganized; and
   a list PRIOCOPIE of objects to be copied in decreasing priority order as a function of the age of the last copies of the objects to be copied;
(50)—Continuously monitoring the occurrence in the information system of any event:
   RAZR=1 for which the selection of the first or next object to be reorganized POR must be reviewed, in particular a reorganization task ending in a reorganization processing region and/or the release of a processing area for reorganization or copying; and/or
   RAZC=1 for which the selection of the first or next object to copy POC must be reviewed, in particular at the end of a copying task in a copying processing region, priority copying at the end of reorganization and/or the release of a processing area for reorganization or copying, with
for an event RAZR=1, launching the execution of the process IDPOR of identifying the first object to be reorganized POR or, if the process IDPOR is being executed, interrupting and relaunching the process IDPOR; and/or
for any event RAZC=1, launching execution of the process IDPOC of identifying the first object to be copied POC or, if the process IDPOC is being executed, interrupting and relaunching the process IDPOC;
   the process IDPOR comprising the following operations:
      (51)—Establishing a rapid reorganization schedule PRR* with the aid of the list PRIOREORG and the remaining reorganization operational time TRR available in all of the reorganization regions and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
      (52)—Establishing a rapid copying schedule PRC from the list SELECT/OR, and then establishing, from the list PRIOCOPIE and within the limit of the remaining copying operational time TRC available in all of the copying regions, a selection list SELECT/OC in LIFO or stack memory for objects OC to be copied stacked in decreasing priority order;
      (53)—Setting up a retro-active copying schedule in which, for any current object to be reorganized extracted from the list SELECT/OR in increasing priority order, the time TCR to be reserved for copying the object OR after reorganization is calculated for each copying region;
      (54)—Setting up a retro-active reorganization schedule in which, for any current object OR to be reorganized extracted from the list SELECT/OR in increasing priority order to promote the processing in advance of objects of the greatest possible sizes, the last time DDR of the region is calculated for each reorganization region, representing in the “Batch” window allocated to “offline” reorganization the minimum time necessary for reorganizing the object OR, in accordance with a different formulation according to whether a copy of the object OR being reorganized must be made or not;
      (55)—Identifying the processing region RTR of the current object OR by optimized matching of the processing time DRR available in said region with the processing time DROR necessary for reorganizing the current object OR with minimum DRR−DDL≦0 if no copying is to be done or with minimum absolute value of DRR−DDL and DROR+DCOR≦DRR if copying is to be done;
      (56)—Entering the current object OR as the next object to be reorganized POR in the schedule of the region identified by setting the pointer POR corresponding to the address of the object OR, increasing the consumed time DCRR in the region by the reorganization time DROR and recalculating the time DGRR wasted in the reorganization region because of copying the objects OR at the end of reorganization;
      (60)—Launching the reorganization of the object POR immediately an identified reorganization processing region RTR is available and if there is no reset event RAZR=1 in the meantime; resetting and re-executing the process IDPOR; and
   the process IDPOC comprising the following operations:
      (51)—Establishing a rapid reorganization schedule PRR* with the aid of the list PRIOREORG and the remaining reorganization operational time TRR available and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
      (52)—Establishing a rapid copying schedule PRC from the list SELECT/OR, and then establishing, from the list PRIOCOPIE and within the limit of the remaining copying operational time TRC available in all the copying regions, a selection list SELECT/OC in LIFO or stack memory for objects OC to be copied stacked in decreasing priority order;
      (53′)—Establishing a retro-active copying schedule with determination of the available copying times in the copying region, unstacking of the list SELECT/OC from top to bottom and searching for a copying region by matching the available copying time and the copying time of the current object OC to be copied so as to copy the largest possible objects, and marking the source of the reorganization or non-reorganization of the object to be copied; followed by
   identifying the processing region RTC of the object to be copied by matching the processing time available in said region with the processing time necessary for copying the current object OC; followed by
   entering the current object OC as the next object to be copied POC in the schedule of the identified region RTC by setting the pointer POC corresponding to the address of the object OC and reducing the available processing time by the time to copy the object OC retained as POC;
      (60′)—Launching the copying of the object POC immediately a copying processing region TRC identified is available and if there is no reset event RAZC=1 in the meantime; resetting and re-executing the process IDPOC.

Of course, without departing from the scope of the invention, there exist in variants of the method of the invention certain cases of objects OR to be reorganized for which copying immediately after reorganization is not necessary. In such cases, and for these particular objects, the above operational phases are modified accordingly.

In particular, in a search for continuous optimization, one variant of the management method of the invention integrates into the final phases of the process IDPOR for an object OR a phase of searching for one or more objects OR to be reorganized without copying OR in the list SELECT/OR or by default in the list PRIOREORG liable to be reorganized in the corresponding processing region RTR during the time waiting for copying of the object OR after reorganization.

The phase (51) of establishing a rapid reorganization schedule PRR* advantageously comprises the following operations (see FIG. 3):
(511)—Initialization: wherein the selection indicators of the objects OR are eliminated and the review counter-limiter, the remaining copying time TRC, the remaining reorganization time TRR and the minimum time E for reorganizing and copying an object OR are initialized;
(512)—Loop on objects: wherein a ‘selection possible’ mark is applied for any real object OR from the list PRIOREORG processed in decreasing order until TRR<E;
(513)—Eliminating intersections of objects: wherein real objects OR from table spaces also known as global objects already selected in whole or in part are eliminated from the ‘selection possible’ mark;
(514)—Reviewing preceding choices: wherein objects OR whose total reorganization and copying time is greater than the remaining reorganization time TRR are eliminated from the ‘selection possible’ mark, and by default the current object OR and the objects OR already selected in the list SELECT/OR are subjected to a process of optimization as a function of the reorganization benefit with replacement of an object already selected by the current object with tests, within the limit of the term of the counter-limiter, of successive combinations tending to retain to be finally selected in the SELECT/OR list of objects with the greatest possible reorganization benefit and associating them with the other objects OR of the ‘possible selection’ mark so that the total time for reorganizing all of the objects OR retained is less than but as close as possible to the remaining reorganization time TRR;
(515)—Verifying the sufficiency of the available copying time in the remaining copying time TRC for each object OR currently being finally selected for reorganization, taking account of the reorganization priority of the object OR relative to objects to be copied before it because of their higher copying priorities;
(516)—Selecting the current object OR in the list SELECT/OR: wherein the indicators of the current object OR and of the associated global object are set, where applicable the indicators of the deselected object or objects OR are eliminated, and TRR and TRC are decreased by the reorganization and copying times, respectively.

Said phase (52) of establishing a rapid copying schedule PRC advantageously comprises the following operations (see FIG. 4):
(521)—Initialization: wherein on exiting a reorganization schedule PRR* the copy selection stacks PSC1 and PSC2 are emptied and the review counter-limiter, the remaining copying time TRC and the minimum time EC to copy an object OC to be copied are initialized;
(522)—Inspecting reorganization regions: wherein for all the regions,
if the region is active, and if image copying of the object being reorganized is to be done and/or if image copying of any object OR from the list SELECT/OR taken in decreasing priority order is to be done: for any sub-object liable to be copied separately, in particular a partition, the copying time of the sub-object of TRC is subtracted and the sub-object is placed at the top of the first stack PSC1;
(523)—Processing the list PRIOCOPIE of objects to be copied: for any object OC to be copied from the list PRIOCOPIE taken in decreasing order until TRC<EC and absent from PSC1, the copying time of the sub-object OC is subtracted from TRC and the sub-object OC is placed at the top of the second stack PSC2,
(524)—Stacking selection stacks: the stack PSC1 is placed on top of the stack PSC2 to constitute the list SELECT/OC.

Said phase (53) of establishing a retroactive copying schedule in the process IDPOR advantageously comprises the following operations:
(531) Initializing the copying regions: wherein on exiting a reorganization schedule for all the copying regions, the consumed time DCRC of the region is set to zero;
(532) Determining the copying time TCR to be reserved: wherein for any real object from the list SELECT/OR scanned in increasing priority order and then taken as the current object OR to be reorganized:
   the time TCR to be reserved for copying the current real object OR is set to zero;
   if image copying of any object OR from the list SELECT/OR in increasing priority order is to be done: for any sub-object liable to be copied separately, in particular partition, a search is made for a copying region whose consumed time DCRC is minimal, the copying time of the sub-object is added to the consumed time DCRC of the current region and the time TCR to be reserved for copying the current object (=maximum of the time TCR to be reserved for copying the current object and the consumed time DCRC in the region) is set.

The retro-active reorganization scheduling phase (54) in the process IDPOR advantageously comprises the following operations:
(541)—Initialization: wherein for any reorganization region:
   Time DRR of the region=Time DFB of the ‘Batch’ window less the estimated relative time HRFR of the end of reorganization processing in progress in the region
   Time consumed in the region DCRR=0
   Time wasted in the region DGRR=0
   Pointer to the first object to reorganize in the current region=0
(542)—Determining the last time DDRR of the reorganization region: for any real object OR selected from the list SELECT/OR in increasing priority order:
For each region, if image copying of the current object OR is to be done, calculating the last time of the region DDRR=reorganization time DROR of the current object+maximum of the time TCR to be reserved for copying the current object and the total consumed time DCRR of the region+the wasted time DGRR of the region;
   If not, calculating the last time DDR of the region=consumed time DCRR of the region+maximum of the reorganization time DROR of the current object and the wasted time DGRR of the region.

The phase of identifying the reorganization region RTR (55) advantageously comprises the following operations:

According to the type of current object OR to be reorganized:

(551)—Searching for the reorganization processing region liable to accommodate optimally an object OR to be reorganized without copying, comprising:
   searching for a region whose last time DDRR is minimal, and if the last time DDR of the current region is greater than the time DRR of the current region, searching for a region for which the time DRR of the current region minus the last time DDRR of the current region is minimal and positive or zero; if not
(552)—Searching for the reorganization region liable to accommodate optimally an object OR to be reorganized with copying, comprising:
   Searching for a region such that the absolute value of the time DRR of the region minus the last time DDRR of the current region is minimal and the reorganization time DROR plus the time TCR to copy the current object is less than or equal to the time DRR of the region.

The phase of writing the object OR into the schedule of the reorganization region RTR (56) advantageously comprises the following operations:
(561)—Writing the object OR as the next object to be reorganized POR: wherein if image copying of the current object is to be done or the wasted time of the current region is equal to zero, the first object to be reorganized pointer POR of the current region is set to the address of the current object OR,
(562)—Updating DCRR and DGRR: wherein the reorganization time DROC of the current object is added to the consumed time DCRR of the current region and the wasted time DGRR of the current region is set to the last time DDRR of the current region minus the consumed time DCRR of the current region.

The phase (53′) of establishing a retro-active copying schedule in the process IDPOC advantageously comprises the following operations:
(531′)—Initializing the copying regions: wherein for all regions:
   the region time DRCOP is set to the “Batch” window time DFB less the estimated relative time HRFC of the end of the current copying processing,
   the consumed time DCRCOP of the region is set to zero,
   the pointer POC of the first object to be copied of the current region is set to zero,
(532′) Unstacking and identifying the next object to be copied POC: for any object from the stack PSC1/PSC2 scanned from top to bottom a current object OC to be copied is extracted when the copying time TCOC of the current object is less than or equal to the longest DRCOP;
To identify the copying processing region, searching for a region whose consumed time DCRCOP is minimal; in the event of a result in the affirmative, if the copying time TCOC of the current object is greater than DRCOP minus DCRCOP a region is searched for in which DRCOP minus DCRCOP minus TCOC is minimal, positive or zero,
If no region is suitable, a region to copy is chosen for which the absolute value of DRCOP minus DCRCOP minus TCOC is negative and minimal and for which TCOC is less than or equal to DRCOP;
If the current object belongs to the second stack PSC2, i.e. an object to be copied that does not result from a reorganization, the pointer POC of the object for the chosen current region is set to the address of the current object OC to write the object POC into the schedule of the identified copying processing region RTC; and
To terminate, the copying time TCOC is added to the consumed time DCRCOP of the current region.

According to diverse embodiments of the method of managing “offline” reorganization in processing regions, it is possible to choose events internal to the system that review the selection of the object POR or POC that are the most appropriate for the selection processes used.

In particular, the events RAZR=1 and RARC=1 internal to the system leading to reviewing the selection of the objects POR or POC are respectively the end of a reorganization task in a reorganization processing region for the objects POR or the end of a copying task in a copying processing region for the objects POC, priority copying at the end of reorganization, and/or releasing of a processing area for the objects POR and POC.

Whether used in parallel with the method suited to “offline” reorganization or not, the invention proposes a method of managing reorganization of a set of indexed databases of an information data processing system adapted to the “online” reorganization and characterized in that it comprises at least the following operational phases:
a phase of instantaneous analysis of at least one object OR to be reorganized from among the objects liable to be reorganized, in particular databases, partitions and/or indexes to be reorganized, and estimation of the overcost associated with the level of disorganization of the object OR to be reorganized;
a phase of instantaneous estimation of the cost of online reorganization as a function of the size of said object OR to be reorganized and of the level of disorganization of said object OR to be reorganized; and
   a phase of determination of the minimum disorganization threshold Ds of the object OR to be reorganized above which threshold “online” reorganization may be launched for that object OR and where applicable the effective launching of that online reorganization, the threshold Ds corresponding substantially to the minimum of the total of the estimated overcost of disorganization and the estimated cost of reorganization for the object OR concerned.

In a first variant, launching “online” reorganization is delayed pending a time window of reduced activity of the database concerned. In a particular variant of the invention the management method incorporates a phase of calculating the optimum time for launching an “online” reorganization as a function of the real or predicted activity of the corresponding information system.

At a more global level, the “online” and “offline” reorganization methods are combined so that for an object OR selected as the next object to be reorganized (POR), priority is given to “offline” reorganization, “online” reorganization being required only after crossing the threshold Ds. It is therefore possible to offload “offline” reorganization by means of “online” reorganization provided that the latter does not unduly penalize the quality of online services.

The invention also provides a method of managing “online” and “offline” reorganization, characterized in that for an object OR to be reorganized selected as the first object POR to be reorganized priority is given to “offline” reorganization, “online” reorganization being required only after the threshold Ds is crossed for the object POR concerned.

In a first version of the method of managing “online” reorganization used for the reorganization of indexed table space databases, the method being characterized in that for an object OR to be reorganized, the threshold Ds is defined, when U the hourly mean number of updates to the object OR is low, by an approximation given by the following formula F5′:
R=Ds²rCo*/2.l.c=1
in which:
r designates the mean number of rows or key-RID per page of the entire object,
l designates the number of row or key-RID insertions for the indexes at the time in the object OR,
Co* designates the hourly overcost when the object is totally disorganized, and
c designates a machine parameter, the ratio of the access time E/S to the size Nbp of the object.

In a variant of the above “online” reorganization management method used for the reorganization of indexes, the threshold Ds¹ is defined, when U the hourly mean number of updates to the index is low, by an approximation given by the following formula F7′:
R=DsI2r(t*+1)Nbp.V/[2(V+3)]=1
in which:
V=Ts/Tl,
Ts designates the arm displacement time, Tl designates the latency time (½ arm turn), c=(Ts+3.Tl)/Nbp, and
   t* designates the rate of rereading of the object, i.e. the mean number of times that an entry will be reread.

In another variant of the above “online” reorganization management method used for the reorganization of indexed monotable space databases with n indexes, the threshold DsT is defined for a monotable space, when U, the hourly mean number of updates to the monotable space, is low, by an approximation given by the following formula F13′:
R=r.Nbp[DsT².L(V+1)+V.S(DsT²−bi²)(t*i+1)]/(2V+6)=1
in which:
L designates the proportion of rows accessed per sequential scan to the number of rows created,
S represents the mathematical symbol Σ, denoting the sum of the expressions f(xi) for values of the index i from 1 to n,
bi represents the instantaneous values of D, the level of disorganization of the monotable space, at the time of the last reorganizations of the n indexes, and
   t*i represents the rate of direct access via each index i.

The invention also provides a method of managing reorganization in a set of indexed databases of all the above variants of an information data processing system applied to reorganizing indexed table space databases.

The invention further provides information system type data processing systems comprising a set of indexed databases and hardware and software means adapted to implement the above method of managing reorganization of indexed databases, in particular table space and/or indexed databases.

Other features and advantages of the global method according to the present invention of managing reorganization of indexed databases and its application to the reorganization of indexed databases of the table space type in particular will emerge on reading the following description, given with reference to the appended drawings, of a preferred embodiment of the invention offered by way of nonlimiting example.

### BRIEF DESCRIPTION OF THE DRAWINGS

FIG. 1 represents a flowchart corresponding to the method of the invention of managing the reorganization of a set of indexed databases, in particular databases of the table space type;

FIG. 2 represents a flowchart corresponding to the method of the invention of managing the reorganization and copying of a set of indexed databases, in particular databases of the table space type;

FIG. 3 represents a flowchart detailing the operations of a phase of the FIG. 2 method for establishing a rapid reorganization schedule;

FIG. 4 represents a flowchart detailing the operations of a phase of the FIG. 2 method for establishing a rapid copying schedule;

FIG. 5A represents a flowchart corresponding to a method usable in the context of the invention to read an indexed database, in particular with a view to reorganizing the database;

FIG. 5B represents a flowchart corresponding to a method usable in the context of the invention to read the index of the indexed database, in particular with a view to reorganizing the index;

FIG. 6A represents a flowchart corresponding to a partial variant of the FIG. 5A method usable in the context of the invention to read and download the index of an indexed table space database, in particular with a view to reorganizing the indexed database;

FIG. 6B represents a flowchart corresponding to a partial variant of the FIG. 5B method usable in the context of the invention to read and download the index of an indexed table space database, in particular with a view to reorganizing the index of the indexed database;

FIG. 7 represents a flowchart corresponding to a partial variant of the method usable in the context of the invention to read and download the FIG. 6A table space indexed database;

FIG. 8A represents a flowchart corresponding to a method usable in the context of the invention of reorganizing an indexed database of the table space type using the FIGS. 6A and 7 reading and downloading methods; and

FIG. 8B represents a flowchart corresponding to a method usable in the context of the invention to reorganize the index of the FIG. 8A indexed table space database using the FIG. 6B reading and downloading method.

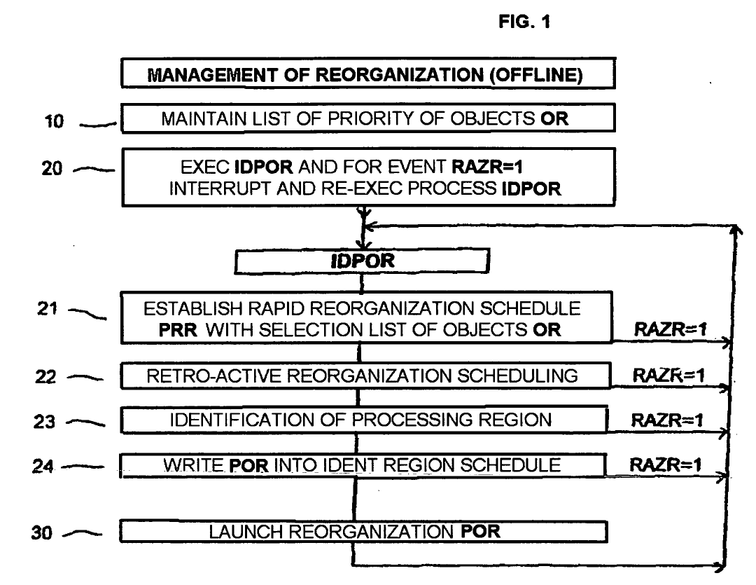

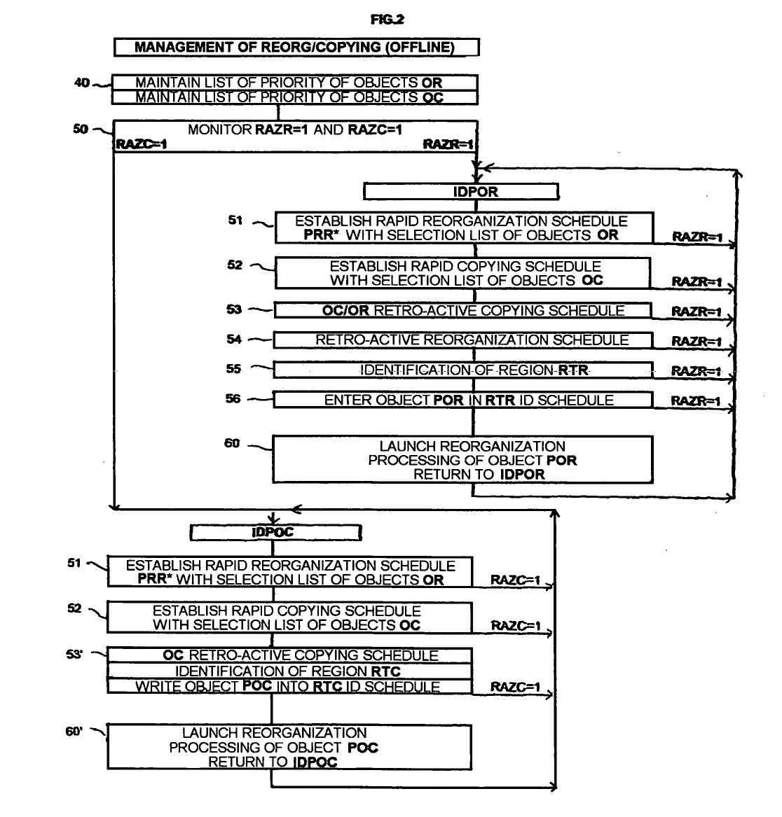

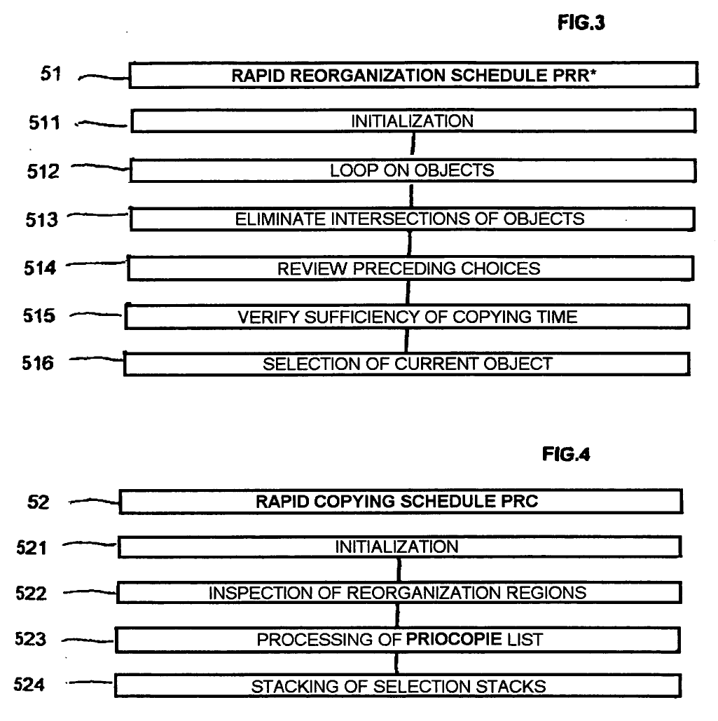

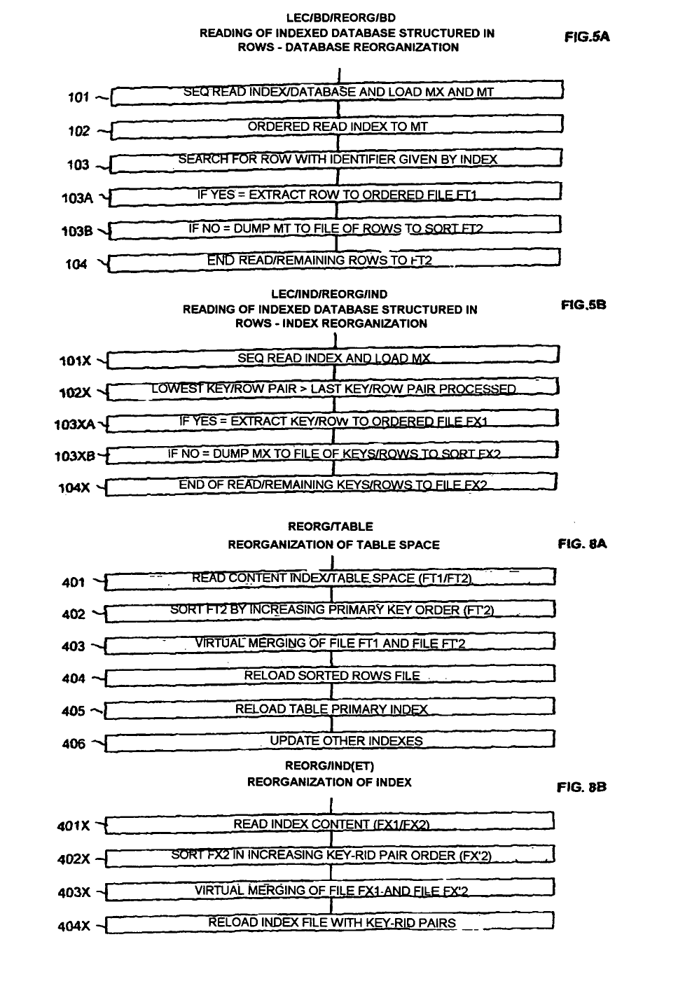

The following description of the global method of managing the reorganization of a set of indexed databases, which is offered by way of non limiting example, relates to a particular application of the invention to indexed table space databases liable to reach a very large size (up to a few billion rows), and for which maintaining good organization is crucial from the performance point of view, in particular through rapid and efficient reorganization.

Examples of Indexed Databases, Table Space Databases:

An indexed table space database consists of one or more files formed of blocks of a single size or pages numbered in sequence from zero. From the logical point of view, there is only one file consisting of the succession of each of the physical files numbered 1, 2, etc.

These pages include control pages and data pages adapted to contain rows, each row being identified uniquely by its RID consisting of the page number and the serial number within the page. Each row is made up of data fields known as columns. A key is a list of columns in increasing or decreasing order. Each key is associated with an index.

A table space may contain one or more tables each having specific columns. Nevertheless, multitable table spaces may be treated as monotable table spaces provided that the tables and their indexes are processed in sequence.

The table spaces may be partitioned (i.e. divided into several portions also known as partitions). Each partition is then identical to the physical file carrying its number.

When the database is created, a data free space and an index free space are provided each consisting of empty pages distributed in the table space and in the index; the object of providing empty pages between certain data and index pages is to allow additions and other updates of rows of data or index keys in the vicinity of the corresponding pages, and thus to limit excessive disorganization.

A table space is considered to be well organized if:
the data free space (empty pages) is distributed in the table space in accordance with the original parameters; and
the rows are arranged in RID order in the same order as the first key, known as the ‘primary’ key.

Like the table space, the index comprises one or more files formed of pages. The pages are of several types, in particular control pages, ‘sheet’ pages and higher level pages. The sheet pages contain keys and for each key the RID or the RIDs of the table space row or rows whose corresponding key has the same value. Thus each table space row is associated with an index sheet page key-RID pair.

Each sheet page contains a contiguous set of key-RID pairs, i.e. there is no off-the-page pair between two on-the-page pairs. The sheet pages are therefore logically ordered with reference to any of their elements.

In the case of table space partitions, the same applies to its primary index, an index partition being associated with each partition of the table space.

An index is considered to be well organized if:
the free space is distributed in the table space in accordance with the original parameters; and
the sheet pages are stored by number in the same order as the keys.

The above definition of a table space indexed database is valid for the remainder of the description.

The individual reorganization of a database (and its index) generally entails downloading the database, storing its information rows in a required order, for example alphabetical order, and then uploading the rearranged rows into the database and updating the indexes, if possible in reorganized fashion.

Example of “Offline” Reorganization of Indexed Databases, in Particular of Indexed Table Space Databases:

Again by way of nonlimiting example, there is used for the individual reorganization of indexed databases structured in rows, and in particular indexed table space databases, a reading (downloading) mode and a reorganization mode significantly reducing the time necessary for ordered reading of the indexed database (reading and where applicable continuous or discontinuous sorting) and/or reorganizing the indexed database.

In particular the LEC/BD/REORG/BD method is generally used to read indexed databases in which the data appears in the form of rows of data, this method comprising the following operations (see FIG. 5A):
[101]—Simultaneous and sequential reading of the index and rows of the database BDD, loading of the indexes into a first buffer memory MX and loading of the rows into a second buffer memory MT,
[102]—Reading of the indexes from the buffer memory MX to the buffer memory MT in ordered fashion,
[103]—Searching the buffer memory MT for a row whose identifier is obtained from the ordered reading of the index,
[103A]—In the event of a result in the affirmative, extraction of the row to a file FT1 of logically ordered rows,
[103B]—In the event of a negative result, partial dumping of the buffer memory to a file FT2 of rows to be sorted and eliminating from the buffer memory MT of at least the lowest numbered page,
[104]—Further reading to the end of the database, remaining rows that it has not been possible to extract in ordered fashion being directed to the file FT2.

Applied to reorganizing the database, the LEC/BD/REORG/BD reading method, after sorting the file FT2 to yield the file FT′2, combines the two ordered files FT1 and FT′2 into a virtual file FTV serving as input for the reloading phase of the reorganization of the database.

It is to be noted that the expression “virtual file” refers to a file that has no real existence in that it is the theoretical product of the virtual merging of two files, but which may be used as a real file on reloading in that the reloading program reads at the same time the file FT1 and in the output file FT′2 of the sorting operation (itself a virtual file generally called the “sorting exit” file) and effects the merging row by row, instead of reading a single file. The expression “virtual file” more generally designates an entity on which the same functions can operate as on a standard sequential file (open, read or write a record, close), and which, from the point of view of these functions, behaves exactly like a standard sequential file.

Accordingly, thanks to the continuous generation of an intermediate file FT1 of logically ordered rows by simple extraction during the sequential reading operation, the number of rows to be sorted present at the end of the scan in the file FT2 is significantly reduced, leading to a significant time saving, as much for the operation of reading the database as for the complete processing of the reorganization of the database.

The LEC/BD/REORG/BD database reading method produces an ordered virtual file of rows of data from a sequential reading of the database, at the same time as minimizing the sorting of a partial intermediate file.

In an analogous fashion, the LEC/IND/REORG/IND method is used to read the indexes of indexed databases in which data appears in the form of rows of data; this method comprises the following operations (see FIG. 5B):
[101X]—Sequential reading of the index and loading of the indexes into a buffer memory MX;
[102X]—Verification of the position of the lowest serial number key/row pair (key/row INF) present in the buffer memory MX, relative to the position of the last pair processed, in particular if the serial number of the key/row pair INF is greater than the serial number of the last pair processed;
[103XA]—In the event of a result in the affirmative, extraction of the key/row pair INF to a file FX1 of logically ordered index pairs;
[103XB]—In the event of a negative result, partial dumping from the buffer memory MX to a file FX2 of pairs to be sorted and eliminating from the buffer memory MT at least the lowest numbered key/row pair; and
[104X]—Further reading to the end of the database, remaining key/row pairs that it has not been possible to extract in an ordered fashion being directed to the file FX2.

Thus the operation of ordered reading of the index, either continuously or discontinuously in the absence of certain index key values, directly extracts a logically ordered index file FX1 and an index file to be sorted FX2. After sorting the file FX2 to obtain the file FX′2, the two ordered files FX1 and FX′2 are merged into a virtual file FXV used as input to the reloading phase of the reorganization of the index.

In practice files FT1 are constituted containing more than 90% of the rows read. Moreover, the duration of a sorting operation is more than proportional to the quantity of input information; it is divided by a factor of at least 10. With regard to the reading time, this remains short because the reading operation is performed sequentially and simultaneously on the database and the index.

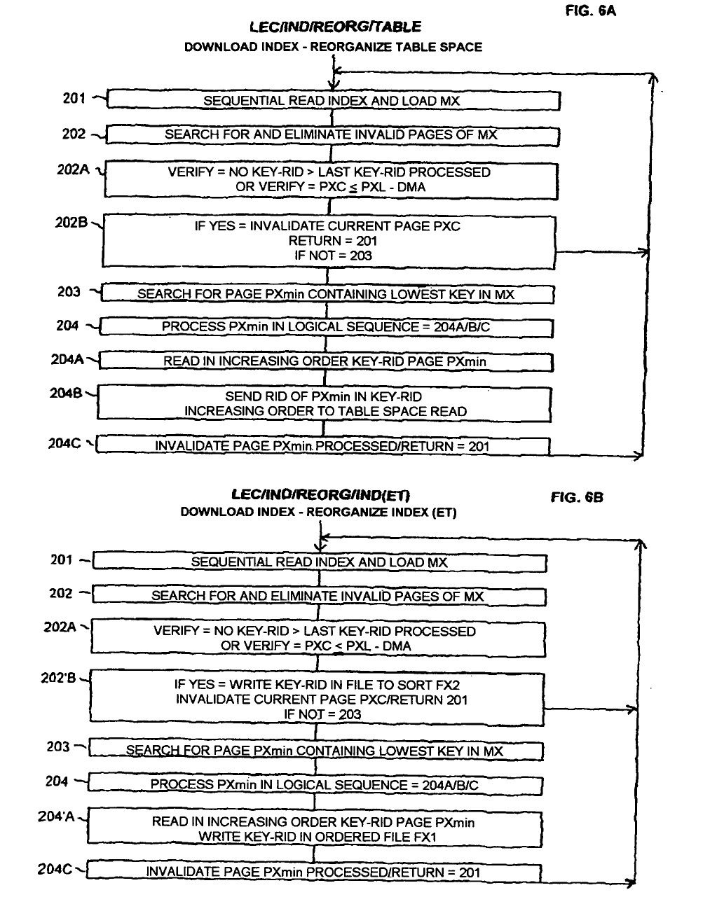

In a first embodiment of the LEC/BD/REORG/BD reading method applicable to a ‘table space’ indexed database, the LEC/IND/REORG/TABLE method is used to read and download the index with the aid of the buffer memory MX; this method comprises the following operations (see FIG. 6A):
[201]—As many times as necessary, until the end of the index is reached and the buffer memory MX has been emptied, sequential reading of the pages of the index, retaining only index pages containing at least one key, until the buffer memory is filled or the end of the index is reached; this reading is effected in unused locations of the buffer memory or locations containing a page marked as invalid;
[202]—Searching for and replacing invalid index pages in the buffer memory MX, starting from the first page of the buffer memory,
[206A]—Verifying in each current page of the buffer memory:
   the absence of at least one key-RID pair higher than the last key-RID pair processed in logical sequence (written into the sorted index file FX1 or sent for table space/database reading); or
   the accuracy of the expression PXC≦PXL−DMA in which PXC represents the number in the index of the current page of the buffer memory MX, PXL represents the number in the index of the last index page read, and DMA represents the maximum authorized difference between index pages being read;
[206B]—In the event of a result in the affirmative of at least one of the two propositions, invalidating the current page PXC and returning to the operation [201] to read a new index page in sequence;
[203]—Searching for the valid page PXmin of the buffer memory MX that contains the lowest key CLE INF in the whole memory or, in the event of equal keys, the lowest corresponding RID;
[204]—Processing the page PXmin in logical sequence comprising the following operations:
[208A]—Where applicable, reading each of the key-RID pairs of the page PXmin in increasing order;
[208B]—Sending each RID of this page PXmin in increasing order of the key-RID pairs to the process for reading the table space database;
[204C]—Invalidating the processed page PXmin and returning to the operation [201] to read a new index page in sequence.

It will be noted that the operation 208B constitutes a simplified index downloading in which only the RID of pages extracted in logical sequence are transmitted and used for the reorganization of the table space.

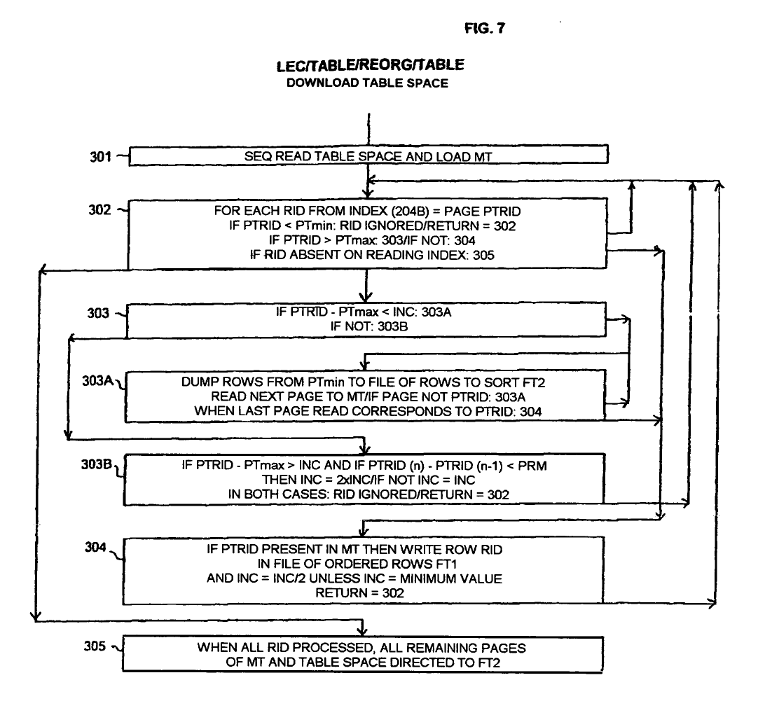

In particular, the LEC/TABLE/REORG/TABLE method of reading and downloading the table space with the aid of the buffer memory MT entails the following operations (see FIG. 7):
[301]—As many times as necessary until reaching the end of the table space and emptying the buffer memory MT, sequential reading of the pages of the table space or of the partition from the beginning, retaining only data pages containing at least one row, until the buffer memory MT is filled or the end of the table space is reached;
[302]—For each RID present and resulting from reading the index (see operation 208B):
   if the RID designates a page number PTRID less than the lowest (minimum) page number PTmin of the page numbers in the buffer memory MT, the RID is ignored because the page has already been processed; return to the start of the operation [302];
   if the RID designates a page number PTRID greater than the highest (maximum) page number PTmax in the memory MT, the page has not yet been read and the operation [303] is effected; otherwise the operation [304] is effected;
   if the RID is absent, the operation [305] is effected;
[303]—If PTRID−PTmax≦INC, where INC (the authorized increment) represents the maximum number of pages from the table space that may be read to retrieve a given RID, then the operation [303A] is effected as many times as necessary to obtain the page carrying the RID number; by default the operation [303B] is effected;
[303A]—Dumping the content of the page of the memory MT having the lowest (minimum) page number PTmin by sending the corresponding rows to the sort table space file FT2; reading, at the location of Pmin, the page of the buffer memory MT after the page PTmax, and repeating this until a data page is obtained containing at least one row; when the last page introduced into the memory MT carries the RID number, then the operation [304] is effected;
[303B]—If PTRID−PTmax>INC, and
if PTRID(n)−PTRID(n−1)<PRM, where the proximity parameter PRM represents the maximum data page number difference that two consecutive RID obtained by reading the index must not exceed, unless there is a gap in the sequence, the two pages PTRID(n) and PTRID(n−1) are probably adjacent and the authorized increment INC is doubled; by default INC remains unchanged; in both cases the RID is ignored and there is a return to the operation [302];
[304]—If the RID designates a page PTRID present in the buffer memory MT (including after the reading operation [303A]), it suffices for the page number to be between the limits, since the buffer memory MT contains contiguous non-empty pages, the corresponding row is written to the ordered row file FT1 and the authorized increment INC is divided by 2, as long as the result is not below its minimum value; there is a return to the operation [302];
[305]—When all the available RID have been processed, all the remaining pages, and where applicable all as yet unread pages of the table space, are dumped from the buffer memory MT to the file FT2.

The above LEC/TABLE/REORG/TABL reading and downloading method is applied in the following manner for the reorganization of indexed table space databases.

In particular the REORG/TABLE method is used for the individual reorganization of an indexed table space database; this method comprises the following operations (see FIG. 8A):
[401]—Sequentially and simultaneously reading the content of the index and the content of the table space and creating data row files FT1 and FT2;
[402]—If necessary, sorting the file FT2 in increasing primary key order and by increasing table order if there is more than one table;
[403]—Virtual merging of the row files FT1 and FT′2;
[404]—Reloading of the file or files containing the table space with the rows ordered in this way or sorted in compliance with the free space parameters;
[405]—Reloading the primary index of each table in the same order and taking into account the new location (RID) of each row;
[406]—Updating the other indexes either by modifying the RID or by reloading them after sorting the key and RID information.

With regard to the reorganization of the index or an index partition of the indexed database, this is liable to use, among other methods, a variant of the index reading and downloading method shown in FIG. 6A constituting a method of reading and downloading indexed table space database indexes with the aid of the buffer memory MX and by the LEC/IND/REORG/IND(ET) method, which comprises the following operations (see FIG. 6B):
[201]—As many times as necessary until the end of the index is reached and the buffer memory MX has been emptied, sequentially reading, in the locations of the buffer memory that are unused or contain a page marked as invalid, the pages of the index, retaining only index pages containing at least one key, until the buffer memory is filled or the end of the index is reached;
[202]—Searching and replacing invalid pages in the buffer memory of the index from the first page of the buffer memory MX,
[206A]—Verifying in each current page of the buffer memory:
   the absence of at least one key-RID pair higher than the last key-RID pair processed in logical sequence (written into the sorted index file FX1 or sent in table space/database read mode); or
   the accuracy of the expression PXC≦PXL−DMA in which PXC represents the number in the index of the current page of the buffer memory MX, PXL represents the number in the index of the last index page read, and DMA represents the maximum authorized difference between index pages being read;
(202′B)—In the event of a response in the affirmative to at least one of the two propositions, writing key-RID pairs into the sort index file FX2, invalidating the current page PXC and returning to the operation (201) to read a new index page in sequence; by default (203) the operation is executed;
[203]—Searching for the valid page PXmin of the buffer memory MX that contains the lowest key in the whole of the memory MX or, in the event of equal keys, the lowest corresponding RID;
[204]—Processing the page PXmin in logical sequence, comprising the following operations:
[204′A]—Reading each of the key-RID pairs of the page PXmin in increasing order and writing the key-RID pairs directly into the ordered index file FX1;
[204C]—Invalidating the process page PXmin and returning to the operation (201) to read a new index page in sequence.

Thus downloading the index by this last method leads to the creation of an ordered virtual file FXV of the key-RID pairs and the REORG/IND(ET) method of reorganizing the index of the indexed table space database then comprises the following operations (see FIG. 8B):
[401X]—Reading the content of the index and creating key-RID pair files FX1 and FX2;
[402X]—If necessary, sorting the file FX2 in increasing key-RID pair order to yield FX′2;
[403X]—Virtual merging of the files FX1 and FX′2;
[404X]—Reloading the file or files containing the index with the key-RID pairs ordered in this way or sorted in conformance with the free space parameters.

Note that the absence of the sorting operation [402] and/or [402X] results from the fact that rows of the table space and/or of the index pages may have been read directly in order, which is what happens if the database is not unduly disorganized.

Accordingly, using sequential reading, enabling a large number of pages to be read in a single operation (the disk units of the system having a contiguous block mass reading function), significantly accelerates the individual operations of reorganizing indexed databases, especially indexed table space databases.

To finish with this individual reorganization aspect, note that although both methods of reorganizing the database REORG/TABLE and reorganizing the index REORG/IND(ET) may be implemented conjointly, it appears that in practice these two methods are coded separately and implemented as coroutines. This is important because it yields more flexibility in preparing the reorganization schedules of all the indexed databases, especially the indexed table space databases.

Having described the individual reorganization of indexed table space databases and their indexes in outline, it is important to return to the topic of the global strategy for the reorganization of all the databases of the information system.

Management of “Online” Reorganization

Strategy

The global strategy integrates “online” and “offline” reorganization. The disorganization threshold from which “online” reorganization is cost effective is determined for each object of the information data processing system. If this threshold is reached without it being possible to reorganize the object “offline” (because of lack of availability in the “batch” window), then “online” reorganization is launched as soon as the level of updating activity is sufficiently low for such reorganization to be valid. This “online” reorganization is effected in a single operation on a copy of the object in service. Any updates that occur during the reorganization operation are saved to an intermediate file that is processed at the end of reorganization (the modified pages being marked with the time of the modification), this process being repeated for any new updates until all have been dealt with. Once reorganized and updated, the object (the database) may then be returned to service.

With regard to the table spaces, sequential index scans of the primary index (the index determining the reorganization sorting criterion) determine the organization of the table spaces. A table space used only in direct access mode does not need to be reorganized because the space maps, which are all that is used to determine the possibility of an insertion, are sufficiently few in number to be retained in the buffer pool.

With regard to the indexes, direct access to the index (by vertical pointers) is used in read mode as well as in updating mode (i.e. for modification of the data field unless otherwise indicated). Its input/output time is determined by whether the pages representing the last two levels, and which must mostly be read physically, are close together on the disk or not. The positioning time for reading the “sheet” page determines the difference between an index that is well organized and an index that is badly organized.

The sequential index scan using horizontal pointers represents only a marginal cost relative to concomitant reading of the table space, as well as having the same performance criterion as direct access, since if two pages are close to a third they are relatively close to each other. The sequential index scan is therefore not involved in determining the necessity for reorganization.

Data Used

It follows from the foregoing description that the data to be taken into account is the data that impacts on the performance of the applications and on cost in terms of reorganization resource. This data is of two kinds, originating either in the characteristics of the object to be reorganized or in the characteristics of the units (processes and utilities) of the information system:
i) the characteristics of the object to be taken into account are those of determine the volume is the state of the object:
S=the number of Cl (physical block or page) of 4 Kbytes of the object, including the index in the case of a table space,
NTL=the total number of rows (RID if index), or the average number per Cl,
D=disorganization factor, i.e.:
   For a table space:
DT=the percentage of rows far from the page that originally contained the preceding key in the direction of the primary index;
   For an index:
Dl=the percentage of sheet pages situated far from the non-sheet page that points up.

To calculate the number of rows or RID, the usable size of the Cl multiplied by the estimated filling rate is divided by the typical size of the input.

The usable size of a Cl is close to 4 K for a table space and depends on the index type, the number of subranges and the length of the keys for an index of type 1.
The estimated filling ratio, which is 0.85 for a table space, is 0.75 for an index.
The typical size is the geometrical mean (n^{th} root of the product of n numbers) between the maximum size and the minimum size (tmg²=tmax.tmin). For a multiple index the size of the RID is the minimum and the size of a single input is the maximum. For a table space add 8 (prefix+ID) to the size of the row (to be divided by 3 in the event of compression).
ii) The characteristics of the units to be taken into account are those that impact on the input/output time of the processes and utilities:
   the mean positioning time Ts;
   the latency time Tl, i.e. the time necessary for the disk to make a half-turn;
   the number of 4K blocks per memory track on disk.

The application profile is also to be taken into account (this is the mean number of occurrences of an event of the application per unit time, for example per hour).

For a table space, the information used is the mean number of rows read per “index scan” per hour. In fact, note that it is not actually useful to reorganize a table space unless there are read operations in “index scan” mode.

Finally, the instantaneous load is considered when seeking to determine the opportunity to launch an “online” reorganization at a given time. Until now the mean number of updates per object per hour has been used. It would be useful to work on short-term predictions of the load using daily operating profiles.

The Cost of Reorganizing:

The cost of an online reorganization, expressed in Input/Output time, is given by the following formula F1:
C=S.(c+d.D)/(1−e.q.U), in which:
S is the number of pages or size of the object, including the index;
D is the level of disorganization;
c,d,e are constants of the machine (data processing system);
q=1 if the object is an index, otherwise q=index number+1;
U is the hourly mean number of updates of the object, the updates being essentially field modifications in existing rows (with no real disorganizing effect).

It will be noted that the duration of an online reorganization may be very long (several hours for a first continuous reorganization phase of duration t0), leading to the temporary storage, during the first reorganization phase, of a first packet of updates of the object. At the end of this first phase of duration t0 (reorganization elapsed time Tr=t0) there is a second reorganization phase of shorter duration than the first (t1<t0) for processing the first updates, whence the appearance at the end of the second phase (at Tr=t0+t1) of a second packet of updates smaller than the first, and so on until extinction of the updates. As a result of this the final total online reorganization time Tf involves a factor k<1 that is a function of the hourly mean number U of updates of the object.

At the beginning of the reorganization Tr=0
For Tr=t0, C=Co=S.(c+d.D)
For Tr=t0+t1, C=Co+k.Co=Co.(1+k), where k<1
For Tr=t0+t1+t2, C=Co+k.Co+k.k.Co=Co.(1+k+k²)
   Finally, at the end of reorganization Tr=Tf, where:
   Tr=Tf=t0+ . . . +tn+,C=Co+k.Co+k².Co+ . . . +kⁿ.Co+
Thus the final cost is C=Co.(1+k+k²+ . . . +kⁿ⁺+.)=Co/(1−k)
Which is the formula F1 if k=e.q.U

From the formula F1 the hourly mean cost of reorganization is obtained, where t represents the number of hours between two reorganizations:
Cm=[S.(c+d.D)/(1−e.q.U)]/t i.e. F1′
The Cost of not Reorganizing:

The overcost per processing hour of not reorganizing is C*=Co*.D, where Co* is the hourly overcost when the object is totally disorganized.

Generally speaking the disorganization of a table space database is considered to result almost exclusively from insertion of data into the database (creating new rows), i.e.:
D=i/S.r, where
i designates the number of insertions since the last reorganization,
S designates the size of the entire object in pages, and
r is the mean number of rows per page of the entire object.

If it is assumed that the hourly insertion rate I is constant, then:
D=I.t/S.r=>C*=Co*.I.t/S.r, where
I is the number of insertions per hour, and
t is the time elapsed since the last reorganization.

The overcost of not reorganizing for t hours is G=∫Co*.I.t.dt/S.r=½.Co*.I.t²/S.r, that is to say G=½ Co*.D.t, where ∫ designates the integration mathematical function.

The mean hourly cost of not reorganizing is thus: Cm*=½.Co*.D (formula F2).

The Optimum Time for Reorganization:

The total mean hourly cost of non-reorganization is Cmt=Cm+Cm* It is important to reorganize when Cmt=Cm+Cm* is at a minimum.

Now:
Cm=[S.(c+d.D)/(1−e.q.U)]/t,
i.e. if S=I.t/D
Cm=I.(c+d.D)/(1−e.q.U).r.D (formula F1″)
Cmt=Cm+Cm*=½.Co*.D+[I.(c+d.D)/(1−e.q.U).r.D] (formula F3)

This function, which is of the type a.x+b+c/x, passes through a minimum when a−(C/x²)=0 i.e. x²=c/a, whence the threshold value Ds that is a solution of the following equation:
Ds²=2I.c/(1−e.q.U)rCo* (formula F4)

Alternatively, it may be shown that the function Cmt=Cm+Cm* has a minimum when the terms in D and in 1/D are equal (a.x=c/x), that is to say when
I.C/[(1−e.q.U).r.D]=½.Co*.D.
Whence formula F4.
It is necessary to reorganize when D² exceeds this value Ds², i.e. when:
D²>2I.c/(1−e.q.U)rCo*
or, to put this condition in another form, when:
R′=D²rCo*.(1−e.q.U)/2.I.c>1
Or when R′=R(1−e.q.U)>1
Where R=D²rCo*/2.I.c (formula F5).
Given that e.q.U must be as small as possible, the online reorganization will occur when U (the hourly mean of the number of updates of the object) is low from the time at which R>1.

Thus the threshold rate Ds is given by the following formula F5′:
R=Ds²rCo*/2.I.c=1
I) If the Object is an Index

If the object is an index, each insertion costs n read operations and 1 write operation, where n is the number of index levels, and each reread costs n read operations. Assuming three index levels, the access time corresponding to the last two levels will be:
Ts+2. TI if the index is reorganized,
2Ts+2 TI if the index is disorganized,
   where Ts is the arm displacement time, TI the latency time (arm half-turn). In the case of a disorganized index, the access time overcost per transaction is Ts.

It is possible to determine the number of transactions as a function of I (the number of insertions per hour): (t*+1) I, where t* is the object rereading rate, i.e. the average number of times an entry will be reread.

As a result, the hourly overcost Co* of not reorganizing when the object is totally disorganized is Co*=(t*+1) I.Ts (formula F6).

It is possible to evaluate c (I/O access time by size) by assuming in the worst case that the “online” reorganization utility reads one track at a time and then loses its position, i.e. by neglecting write operations.
c=(Ts+3TI)/Nbp, where Nbp is the number of pages of the object.

By setting Ts/T1=V, which is a characteristic of the processing unit, the following formula F7 is obtained:
R=D²r(t*+1)Nbp.V/[2(V+3)]

Thus the threshold rate for the index DsI is given by the following formula F7′:
R=DsI²r(t*+1)Nbp.V/[2(V+3)]=1

Consider the following nonlimiting numerical example:
r=200 (key length 10 bytes)
Nbp: 12 (3390)
V=1.76 (3390-2)
t*=1 (only one reread)

Thus R=D² 200.2.12.(1.76)/2.4.76=D² 8400/9.52, i.e. R=887.D²

It will be necessary to reorganize from R>1 (if the rate U may be considered negligible), i.e. for D²>1/887 or D>0.0335, i.e. from an index disorganization threshold rate Ds=3.35%.

ii) If the Object is a Table Space

If the object is a table space, an index scan will generate a disorganization overcost per displaced row of Ts+TI. This results in a disorganization cost:
Co*=L.I.(Ts+TI)
where L is the proportion of rows accessed per index scan relative to the rows created.

Moreover, because the indexes are reorganized simultaneously, it is necessary to take account of the cost associated with direct access via these indexes, thus:
Co*i=(t*i+1).Ii.Ts
whence the total mean hourly cost of not reorganizing is:
Cm*=½.L.I.D.(Ts+TI)+½[SCo*i.Di²./D²].D
that is to say:
Cm*=½.L.I.D.(Ts+TI)+½Ts.SIi.Di².(t*i+1)/D (formula F9)

It is to be noted that:
Ii=I in the case of a monotable table space;
in the general case, it may be assumed that Ii=ki.I where ki designates the relative cardinal of the table associated with the index i (and representative of the relative dimension of that table), which amounts to ignoring updates leading to a modification of the key and assuming that the tables have comparable mean row lives;
t*i represents the direct access rate via each index and thus, for a given table, S t*i represents the cost of access to that table.

Assuming certain index reorganizations have been done, in each interval containing no index reorganization Di is a linear function of the number I of insertions and therefore of D:
Di=ai.D−bi, where ai=Ii.S.r/(I.Si.ri)=ki/ki=1
whence Di=D−bi
Cm*=½.L.I.D.(Ts+TI)+½Ts. SIi.(D−bi)².(t*i+1)/D
Cm*=½.L.I.D.(Ts+TI)+½Ts.SIi.D.(t*i+1)−Ts.SIi.bi.(t*i+1)+½S.Ii.bi².(t*i+1)/D
where Cm=I.(c+d.D)/(1−e.q.U).r.D (mean hourly cost of reorganizing the object).

In an analogous fashion to what has already been described hereinabove, the function Cmt=Cm+Cm* has a local minimum when the terms in D and in 1/D are equal, that is to say:
D²[L.I.(Ts+TI)+Ts.SIi.(t*i+1)]=2I.c(1−e.q.U).r+Ts.SIi.D².(t*i+1)
D².L.I.(Ts+TI)+Ts.SIi.(D²−bi²)(t*i+1)=2I.c/(1−e.q.U).r

Using, as hereinabove, c=(Ts+3.TI)/Nbp and substituting bi=D−Di:
R=r.Nbp[D².L(V+1)+V.Ski(2DDi−Di²)(t*i+1)]/(2V+6) (formula F12)
or
R=r.Nbp[D².L(V+1)+V.Ski(D²−bi²)(t*i+1)]/(2V+6) (formula 12′)

For a monotable database ki=1 and the formula becomes:
R=r.Nbp[D².L(V+1)+V.S(D²−bi²)(t*i+1)]/(2V+6) (formula F13)

Thus the threshold rate DsT is given by the following formula F13′:
R=r.Nbp[DsT².L(V+1)+V.S(DsT²−bi²)(t*i+1)]/(2V+6)=1

Consider the following nonlimiting numerical example, for a monotable table space with two indexes:
r=15 (row length 200 bytes; index size is 15% of the table space size)
Nbp: 12 (3390)
V=1.76 (3390-2)
L=5 (each row is the subject of five scans during its life)
r1=200 (key length 10 bytes)
r2=230 (key length 8 bytes)
t*1=1 (one direct reread)
t*2=2 (two direct rereads)

Proceeding as described above, it is apparent that the first index I1 (R1=887.DI1²) must be reorganized from DsI1=0.0355=3.35% and that the second index I2 (R2=1531.DI2²) must be reorganized from DsI2=0.0255=2.55%.

The database being of the monotable type, ki=1. Formula F12′ is simplified and written as follows:
R=(15.12)/(2.(4.76))[(D².5.(2.76))+(1.76.2(D²−b1²))+(1.76.3(D²−b2²))
that is to say:
R=180/9.52[(13.8.D²+3.52.D²+5.28.D²)−(3.52.b1²+5.28.b2²)]
that is to say, if the values DsT, b1 and b2 are directly expressed in % (percent):
R=[427.DsT²−66.5.b1²−100.b2²]/10.000=1 (formula F14)

It is clear from formula F14 that the table space reorganization threshold value DsT will be greater than the limit Dinf that is a solution of the following equation:
Dinf²=10.000/427=23.4, i.e. Dinf=4.8%.

After a reorganization of the table space and its two indexes, all the disorganization levels are at zero with DT=DI1=DI2=0.

The first index reorganization will occur for DsI2=2.55% (at a time when the database and the first index will have the same rate DT=DI1=2.55% (<Dinf), the rates being proportional to the number of insertions of new rows (or RID in the case of indexes).

The second index reorganization will occur for DsI1=3.35% (at a time when the database will have the same rate DT=3.35% (<Dinf)).

Assuming, to simplify, that the index may be reorganized as soon as the limit rate or threshold is reached, each range defined between two successive index reorganizations may be examined and formula F13 used to calculate the value in this range of the limit rate for the table space (the values of b1 and of b2 being given by the instantaneous value of the disorganization of the table space Ds at the time of the last two index reorganizations) and to verify that this limit value is in the range concerned; by default the range concerned and the limit value calculated will not be adopted.

The following sequence of ranges will therefore be examined:

[0:DsI2], [DsI2:Ds1], [DsI1:2.DsI2], [2.DsI2:2.DsI1], etc., where 2.DsI2 and 2.DsI1 correspond to the second reorganization of the second index and the first index, respectively.

By introducing numerical values, the series of ranges may be written [0:2.55], (2.55:3.35], [3.35:5.1], [5.1:6.7], etc.

Given the value Dinf=4.8%, it is necessary to examine the eventuality of a reorganization of the table space in the range [3.35:5.1], with b1=3.35 and b2=2.55 (value of Ds at the time of the first two index reorganizations−the first one of I1 and the first one of I2).

From formula F14, DsT²=11380/487=26.5 and DsT=5.15%.

This value is not acceptable because it is outside the range concerned. As a result of this the table space may be reorganized only after the second reorganization of the second index I for which DsT takes the value 2×2.55=5.1.

Adopting this procedure for the range [5.1:6.7], with b1=3.35 and b2=5.1, DsT²=13231/487=31 and DsT=5.56%.

Taking U=0, reorganization of the table space and its two indexes is desirable from a disorganization level of 5.56% occurring in the range concerned at a time well ahead of the second reorganization of the first index.

It is to be noted that it is also beneficial to apply the cost effectiveness criterion described hereinabove to “offline” reorganization (hl) if there is data. To do this, it is necessary to replace the coefficient c(el) (input/output time as a function of the size of the object) in formula F1 with a coefficient corresponding to “offline” reorganization, for example of the type c(hl)=K.c(el), where K is the ratio of the execution time of offline (hl) reorganization of the object to the execution time of online (el) reorganization of the same object under average conditions of operation of the corresponding indexed table space database.

It is therefore possible to determine if “offline” reorganization is useful or not. The existing priorities based on levels of disorganization are also replaced by priorities based on cost effectiveness, an object read more than another object having priority for reorganization if the levels of disorganization are the same.

Global Management of “Offline” Reorganization and Copying:

The “offline” reorganization of a file is greedy of machine time, which it is in general desirable to minimize to reduce the total cost of the operation. To this end, the invention also proposes a method of managing or preparing scheduling of the execution in real time of reorganization (and/or image copying) utility programs to make best use of the resources of the information data processing system including the “batch” window (maintenance window).

The success and effectiveness of a method of this kind are based on speed, whether this refers to the speed of preparing and updating an activity plan or scheduling the tasks to be executed and/or the speed of launching the execution of the preselected programs.

Before explaining the management or scheduling method of the invention, it is important to describe briefly the organization and operation of an information data processing system comprising a set of files or indexed databases divided into diverse real objects consisting of table spaces, table space partitions and indexes.

The Information System:

The “machine” capacities of the information system are divided into separate processing regions controlled individually by a control region. Each processing region is assigned a certain number of ordered tasks and the necessary resources in terms of virtual memory and peripherals (hard disks, printers, external storage media, etc.) are allocated. For efficient execution and allocation of hardware and/or software resources, each processing region is if possible assigned tasks of the same type, for example tasks that may generally be executed in the “batch” window for reorganization of files or databases (requiring a great deal of disk space) or image copying of files (requiring external output peripherals, magnetic tape readers, CD-ROM readers/burners, etc.).

Alongside reorganizations of files such as databases, copying modified files constitutes a security imperative in the field of the operation of data processing systems. There are generally three types of copying, continuous copying, also known as log copying, incremental copying, which processes only modifications made to the files, and total copying, also known as image copying.

With regard to databases, operating systems fairly often comprise a software locking device to prevent the database being returned to service before image copying. This creates an interaction between the reorganization and copying schedules.

The Schedules:

The reorganization and copying schedules are based on lists of priorities of objects to be reorganized or copied that will be processed in different processing regions reserved either for reorganization or for copying.

The scheduling method generates the real objects susceptible to reorganization in advance, instead of combining objects in real time. The number of objects is greater for partitioned objects, but the priorities, and consequently the logical order of the reorganizations, are calculated initially and rarely reviewed.

Because of this the objects to be reorganized may be sorted by decreasing priority, even if certain of them are mutually exclusive.

Copying uses other regions and may operate on the individual objects. The list of objects to be copied is therefore separate from that of objects to be reorganized, where applicable with a link for establishing if an object to be copied is also to be reorganized or forms part of an object to be reorganized.

The scheduling or schedule creation process may be summarized in the following manner, both for copying and for reorganization:
Determining or preselecting objects to be given priority for processing by producing a rapid schedule.
Attempting to create a processing execution order list by “retro-active scheduling” to place preselected objects in order of increasing priority in available processing regions, which gives the maximum time for starting a process. Thus the last object successfully selected in a region to complete the list becomes the next object to process POC or POR. By default, a new list creation attempt will be made based on other hypotheses with regard to processing region placement or assignment.

This process is repeated each time that processing (copying or reorganizing) is finished, taking account of the real state of the objects at that time.

The benefit of the “retro-active scheduling” or reverse scheduling operation is that it enables large objects that do not necessarily have priority to be processed before it is too late (before the processing time still available in the “batch” window of the free processing regions becomes insufficient).

In reality execution times vary and it is necessary to apply an execution time safety margin (Kc=1.20 for copying and Kr=1.50 for reorganization).

In practice, each time that a region intended for reorganization becomes available, the reorganization scheduling algorithm looks for the real object with the maximum priority (rapid scheduling), preselects it, and continues to attempt assignment on the same principle by examining the consequences of its initial selection (first object to be reorganized). In particular:
if the object in the assignment phase is a partition contiguous to a partition of the same table space already selected first, then this new partition will be added to the initial selection by way of linked objects provided that the maximum number of partitions selected to be processed together has not yet been reached (all selected contiguous partitions are reorganized at the same time);
if the object in the assignment phase is the table space whose index is the object of the initial selection, the table space (and its indexes) replace the index of the initial selection and any selections of other indexes are cancelled (the indexes of a table space are always reorganized with the space).

The process is partly repeated on each modification of the object selected first (initial selection). Because of this, if many table spaces of the information system are partitioned, the number of reviews may be large.

In an analogous fashion, each time that a region intended for copying becomes available, the copying scheduling algorithm looks for the individual object with the maximum priority (rapid scheduling), and revises a reorganization schedule to verify if that object is intended for reorganization in the “batch” window or not. If it is, then the object is removed temporarily from the copying schedule.

Moreover, priorities are compared between the ‘reorganization’ lists and the ‘copying’ lists; higher priority image copies are liable to prevent reorganization simply because the latter generates a copy and vice-versa.

Rapid Scheduling:

Rapid scheduling determines the objects to be processed, limiting the global processing time (the load) to the sum of the times available in the various processing regions.

Rapid scheduling of copying takes objects in decreasing priority order and is therefore as simple as sorting an object. It yields a rapid evaluation of the residual window time as a function of priority. It may be adjusted as a function of the objects added by the rapid reorganization schedule.

The rapid reorganization schedule takes account of the links between real objects:
if one object is contained within another, the container object is scheduled; and
if two objects have a common partition without one containing the other, the object with the higher priority is scheduled.

Rapid reorganization scheduling also works in decreasing order but is able to review the elimination of large objects at the end of windows.

The rapidity of rapid scheduling stems from their limited backward steps and the fact that they do not review the priorities of objects.

The innermost loop accumulates copying times by testing if an object is to be both copied and reorganized. Because the complete path is necessary only if incompatibilities or reviews are detected, it is possible to introduce a cursor on the object to be copied.

Priorities:

The relative priorities of copying and reorganization are taken into account in the following manner:

For reorganizations necessitating an image copy, it is verified that it is possible (rapid scheduling) by attempting to insert the object into the temporary copying schedule (if it is not already there), together with its reorganization priority.

Thus if the copying regions limit the number of objects, the limit will apply to neighboring priorities both for reorganizing objects necessitating an image copy and for copying other objects.

On the other hand, if the reorganization regions limit the number of objects, objects of much lower priority may be copied.

Specifications of the Method of Managing and Scheduling the Execution of Utility Software for Reorganizing Indexed Databases Data

Individual Objects

Individual objects are the smallest objects liable to be processed (reorganized and/or copied) for which it is possible to measure a level of disorganization.

These objects are used for image copying and as intermediaries for generating reorganization objects.

The individual objects for which an image copy is to be made are chained together (in the PRIOCOPIE list) in decreasing priority and increasing size order (the highest priority being given to the object whose latest copy is the longest standing). Insertions after reorganization are effected at the top of the PRIOCOPIE list.

All the individual objects copied (including subsequently, after reorganizing them) comprise a stack pointer in the increasing priority order that is set by the copying schedule.

Real Objects

Real objects are objects that may be reorganized without reorganizing other objects (for example: table spaces+index not considered separately). Real objects are created from individual objects (table spaces, index and partitions).

The priority of each real object is the center of mass of the levels of disorganization of the components, with their sizes for coefficients. The level of disorganization of an object is given by the ratio of the number of insertions (rows or RID) to the size of the object. Real objects are stored in decreasing priority order in the list of reorganization priorities (PRIOREORG).

The priority being defined as the benefit/cost ratio, the benefit of an object is calculated as the product of its priority by the time to reorganize it.

Real objects are forward-backward chained to enable scanning in both directions and eliminating and changing priority each time that a reorganization is launched.

Rapid scheduling also uses a deletion list (SUPP) for deferring the deletion of objects until the necessity of such deletion is confirmed by the selection of a current object incompatible with the deleted objects.

It is possible to introduce a sub-chain of selected objects (or objects for which selection has been attempted) to avoid, during the reviewing phase, having to examine numerous combinations of partitions incompatible with previous choices.

Partitioned Object

For a table space containing n partitions there are 2ⁿ−1 real objects which can be reorganized, which is unrealistic. The process is limited to combinations of contiguous partitions in priority order, that is to say to ½n.(n+1) objects. If the maximum number of partitions to be reorganized simultaneously is p<n, the number of real objects is reduced to ½p.(2n−p+1).

It is also necessary to be able to answer rapidly the following questions:
i)—is one object contained with another?
ii)—do two objects have a common partition?

To facilitate answering these questions, each object is associated with a bitmap marked at 1 for each partition of the object and the bitmaps are compared.

Global Objects

Global objects are the table spaces. They are intended to contain information relating to the scheduled portion.

The temporary information used by rapid scheduling comprises:
a pointer to a list of its selected real sub-objects, a non-zero value indicating that a portion of the object is to be reorganized;
an indicator of reorganization of the whole of the table space;
an indicator of copying a portion of the table space;
a bitmap of the reorganization of the partitions of the table space; and
a bitmap of the reorganization of the index partitions.

There is a pointer from each individual or real object to the corresponding global object.

Finally, selected real objects of the same table space are chained together by rapid scheduling in the global object selection list (SELECT/OR).

Processing Regions

Each processing region is assigned either to copying or to reorganization. The search for the next object to be reorganized or copied takes place when a region is released by the end of the preceding reorganization or copying.

Scheduling therefore consists in setting a pointer from the processing region to the next object to be processed.

To enable anticipation, the estimated relative time of the end of processing in progress in the region, which is initially zero, is preserved for each region.

Processing

The processing described hereinafter is described by way of nonlimiting example of one embodiment of the method of the invention of managing reorganization and copying of a set of indexed databases. These processes are open to diverse variants and modifications that fulfill technically identical or equivalent functions without departing from the scope of the invention.

A—Rapid Scheduling

The only object of rapid scheduling is to determine the objects that may be reorganized in the remaining time of the “batch” window, and not to calculate the time of starting reorganization. The only information that may be used comprises the selection indicator of each real object and the assignment indicators (schedule portion and pointers).

The rapid reorganization schedule PRR* comprises the following six operational phases:
Initialization
Loop on objects
Eliminate intersections of objects
Review previous choices
Verify sufficiency of copying time
Select current object

The “Initialization” operational phase comprises the following operations:
for any real object OR from the list, eliminating the selection indicator IndS/OR;
for any global object OG from the list, eliminating the selection list pointer PointLS/OG and eliminating the scheduled portion of the object PPO/OG;
initializing the review limiter to 10 000;
initializing E=minimum processing time=minimum of (individual reorganization time+copying of real objects OR to reorganized);
initializing remaining copying time TRC=time remaining after execution of copying in progress and copies related to reorganizations in progress;
initializing remaining reorganization time TRR=time remaining after execution of reorganizations;
initializing next object to copy POC=first object from final list (in reality this is a virtual list because only the first object on the list is relevant).
   Note:
   1) This Initialization phase beginning the PRR* process is launched in particular at the end of each reorganization (reorganization+copying) task in a corresponding processing region.

In the same way, the priority lists PRIOREORG for real objects and PRIOCOPIE for individual objects are updated at the end of each reorganization task.

2) At the start of reorganization:

TRC=“Batch” window time×Number of copying regions, and
TRR=“Batch” window time×Number of reorganization regions.

The “Loop on objects” operational phase comprises the following operations:

For all real objects from the PRIOREORG list up to TRR<E:
marking the possible selection;
eliminating the pointer from the SUPP list;
initializing provisional copying time TPC=TRC;
initializing reorganization time TR=Reorganization time of the current object OR.

The “Eliminate intersections of objects” operational phase comprises the following operations:

For all the global objects associated with the current object OR, Do: If the pointer from the selection list SELECT/OR of the global object associated with the current object is non-zero (which indicates that there is at least one real object selected),
Do: If the scheduled portion of the global object OG is contained in the scheduled portion of the current object OR:
Do for all real objects B from the selection list:
   If B marked selected then:
   i) Add the additional copying time for B to the TPC
   ii) Subtract the reorganization time for B from the reorganization time TR
   iii) Place B in the elimination list SUPP
   if not
If the scheduled portion of the global object OG has a non-empty intersection with the scheduled portion of the current object:
   Mark selection of the current object OR impossible

The “Review preceding choices” operational phase comprises the following operations:
If selection is possible
   If reorganization+copying time of the current object OR>remaining time in the “batch” window in the available region, then
      Mark selection of the current object impossible
      If not (reorg+copying time<remaining “batch” time)
      If reorganization time (time to reorganize current object)>remaining reorganization time
      Initialize residual benefit=current object benefit
      Initialize remaining time to be saved=reorganization time of the current object−remaining reorganization time
      Do for any real object B (already selected) from the list SELECT/OR beginning with that preceding the current object OR and in increasing priority order for as long as the review limiter>0 and the remaining time to be saved≦0:
         If B is selected, without being a sub-object of the current object, and if B benefit<remaining benefit (=benefit of current object OR)
         Subtract the benefit for B from the residual benefit
         Subtract the reorganization time for B from the remaining time to be saved
         Add the additional time for copying B to the provisional copying time
         Place B in the elimination list SUPP
         Decrement the review limiter
      If the time to be saved is >0
         Mark selection of current object impossible
   If not, selection is possible either because the time to be saved after the elimination of B is ≦0, or because the reorganization time (time to reorganize current object)<remaining reorganization time.

The “Verification of sufficiency of copying time” operational phase comprises the following operations:
If selection is possible
   Initializing additional copying time of current object=copying time of current object
   If copy is to be made for the real current object OR,
   Do for any object from the list of objects remaining to be copied (PRIOCOPIE) for as long as priority of object to be copied>priority of object to be reorganized
      Subtract copying time of object to be copied from provisional copying time
      But if object to be copied is a sub-object of current object to be reorganized
         Subtract copying time of object to be copied from provisional copying time (=remaining copying time)
         If additional copying time of current object>provisional copying time
         Mark selection of current object impossible

The “Select current object” operational phase comprises the following operations:
If selection is possible
   Set selection indicator IndS of current object;
   Set assignment indicator of global object associated with current object;
   Note the scheduled portion PPO of the global object associated with the current object OR;
   Set: pointer (continuation) of selection of current object OR=pointer selection list PointLS of global object OG;
   Set: global object selection list pointer Point LS=current object OR address (current object is added to selection list SELECT/OR);
   Subtract additional copying time of current object from remaining copying time TRC;
   Subtract reorganization time of current object OR from remaining reorganization time TRR;
   If the elimination list pointer is non-zero
      Do for all real objects B from suppression list SUPP:
         If B is marked selected
            Eliminate selection indicator of B
            Add reorganization time of B to remaining reorganization time TRR.

Note: There is no benefit in removing B from the selection list because only real objects OR finally selected and marked by the selection indicator will be considered as such and examined afterwards.

B—Next Object to Copy

The search for the next object to copy is effected each time that a region is released by a terminated image copy or a region is available and a new object has been introduced following a reorganization. The objects must be sorted by decreasing priority and increasing size, with objects resulting from reorganizations placed at the head of the list.

Scheduling is effected from the lowest priority to the highest priority and it is possible for a large object (long copying) to overflow the copying region assigned to it. This situation is acceptable provided that it is certain that the object fits in the region from the remaining copying time point of view, and a valid scheduling technique would be to remove a lower priority object already selected from the region and place it in another region, which would not change the selection for that region.

The next object to copy pointer is set for each region, but for the reasons given above it is recommended that the scheduling be redone each time, even at the outset when all the regions are available.

Finally, it is possible for the copying scheduling process to choose an object that does not (yet) belong to the copying list because its reorganization has not been completed. In this situation a wait state is applied (available region).

The “Next object to copy” process comprises the following two operational phases:
“Select objects to copy”
“Retro-active copying scheduling”

The “Select objects to copy” operational phase comprises the following operations:
Do a rapid reorganization schedule PPR*;
Initialize copying selection stacks to empty;
Initialize remaining copying time TRC=total “batch” window time still available in “copying” regions after execution of current copying;
Initialize EC=minimum (individual time to copy objects OR to be reorganized)
   Do for all the reorganization regions,
   If region is active
      If image copying of currently reorganized object is to be done,
         Do for all sub-objects that may be copied separately (partition) Subtract copying time of sub-object from remaining copy time Place current sub-object at top of first copying selection stack.

Do for all real objects selected from the list SELECT/OR of objects OR to be reorganized in decreasing priority order:
If image copying of the current object OR is to be done,
   Do for all sub-objects that may be copied separately (partition) Subtract copying time of sub-object from remaining copying time Place current sub-object at top of first copying selection stack.
Do for all objects from list of objects OC to be copied in decreasing priority order, for as long as remaining copying time TRC>EC
If copying time of object OC≦remaining copying time TRC,
If object OC to be copied is not already in first stack (object OC is a sub-object; verification is possible by testing reorganized portion of global object in event of partition),
   Subtract copying time of sub-object from remaining copying time

Place current sub-object at top of second copying selection stack. Place first copying selection stack on second (thereby constituting the SELECT/COPIE list).

The “Retro-active copying scheduling” operational phase comprises the following operations:
Do for all copying regions:
Region time=Window time−estimated relative time of end of current processing in region
Region consumed time=0
Initialize first object pointer to be copied of current region to 0.

For all objects from copying selection stack, from top to bottom:
If current object OC copying time≦time of longest region;
   Search for a region whose consumed time is minimal;
   If copying time of object OC>time of current region−time consumed
   Search for a region for which: region time−region consumed time−copying time of current object, either minimal and positive or zero,
   If no region is suitable
      Search for a region for which: region time−region consumed time−copying time of current object is maximal (i.e. whose absolute value is minimal) and copying time of current object≦region time,

If current object OC belongs to second stack,
Set: first object to copy pointer POC of current region=address of current object OC,
Add copying time of OC to consumed time of current region.
   C—Next Object to Reorganize

The next object to reorganize is searched for each time that a region is released by a reorganization that has been completed. The priorities must have been calculated or corrected beforehand and the real objects sorted into decreasing priority order.

As for copying, reorganization scheduling is effected from the lowest priority to the highest priority. Copies generated by reorganizations are scheduled first, which enables an end of reorganization time limit to be calculated for each object that has to be copied.

The available time of each reorganization region is divided into three portions:
1—the time actually consumed by the scheduled reorganizations
2—the time wasted by the time reserved for copying after reorganization
3—the remaining time from the beginning of the first reorganization

The process attempts to fill the time wasted by reorganizing objects not necessitating copying.

When an object to be reorganized is selected, it is removed from the list together with its indexes (where applicable) and all other objects that have partitions in common with the object concerned. The priorities of the other objects that may share an index with it are also recalculated (to take account of the impact of reorganizing the index) and those objects are replaced at the proper places in the list of real objects to be reorganized.

The next object to reorganize process comprises the following four operational phases:
“Retro-active copying scheduling”
“Retro-active reorganization scheduling”
“Processing region identification”
“Writing the object into the schedule”

The “Retro-active copying scheduling” operational phase comprises the following operations:
Do a rapid scheduling
Do for all copying regions:
   Consumed time of region=0
Do for all real objects OR selected from reorganization list SELECT/OR (in increasing priority order)
   Initialize: ‘time to reserve for copying current object’=0
   If image copying of current object OR is to be done,
      Do for all sub-objects that may be copied separately (partition),
         Search for a region whose consumed time is minimal, hereinafter called the current region
         Add copying time of sub-object to consumed time of current region,
         Set ‘time to be reserved for copying current object’=max (time to reserve for copying current object OR, consumed time of current region)

The “Retro-active reorganization scheduling” operational phase comprises the following operations:
Do for all reorganization regions:
   Time of region=Time of window−estimated relative time of end of processing in progress in region.
   Consumed time in region=0
   Wasted time in region=0
   First object to reorganize pointer of current region=0
Do for all real objects OR selected from list SELECT/OR in increasing priority order:
   Do for each region
      If image copying of current object OR is to be done,
         Calculate last time of region=reorganization time of current object+max of [time to reserve for copying current object, (consumed time of region+wasted time of region)]
      If not,
         Calculate last time of region=consumed time of region+max of [(reorganization time of current object, wasted time of region)]

The “Processing region identification” operational phase comprises the following operations:
Search for a region whose delay is minimal,
If last time of current region>time of current region,
   Search for a region for which: [time of current region−last time of current region] is minimal and positive or zero,
If not, if no region is suitable,
   Search for a region such that: [absolute value of (time of region−last delay of current region)] is minimal, and [reorganization time+copying time of current object]≦time of the region.

The “Write object in schedule” operational phase comprises the following operations:
If image copying of current object OR is to be done or wasted time of current region=0,
   Set: first object to be reorganized pointer POR of current region=address of current object OR,
Add reorganization time of current object OR to consumed time of current region,
Set: wasted time of current region=last time of current region−consumed time of current region.

When one of the two identified processing regions concerned (reorganization or copying) becomes available, if there is no reset RAZR=1 or RAZC=1 in the meantime for the process concerned, the system launches either reorganization of the corresponding object POR (next object to reorganize) or copying of the corresponding object POC (next object to copy).

Once processing has been launched, the identification process IDPOR and/or IDPOC resumes, the lists PRIOREORG and PRIOCOPIE being updated continuously, until the reorganization time and/or copying time imparted to the various corresponding reorganization and copying regions in the “Batch” window is used up.

Of course, the method according to the invention of managing reorganization and copying in sets of indexed databases of an information system is not limited to the embodiment described hereinabove and encompasses variants and modifications within the scope of the following claims that might suggest themselves to the person skilled in the art.

In particular, the management method of the invention used for “offline” reorganization of databases is equally applicable to “real time” or “online” reorganization of databases using a combined method, “offline” reorganization and “online” reorganization not being mutually exclusive.

1. Method of managing reorganizations in a set of indexed databases of an information data processing system adapted to “offline” reorganization in at least one reorganization processing region of the system, comprising the following operational phases:
(10)—Creating and maintaining by continuously updating a list PRIOREORG of objects to be organized in decreasing priority order as a function of the level of disorganization of the objects to be reorganized;
(20)—Executing a process IDPOR of identifying the first or next object to be reorganized POR with, at each event RAZR=1 internal to the system for which the selection of the first or next object to be reorganized must be reviewed, interrupting, resetting and re-executing the process IDPOR, which comprises the following steps:
(21)—Establishing a rapid reorganization schedule PRR with the aid of the list PRIOREORG and the remaining operational time TRR available in all of the reorganization regions and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
(22)—Establishing a retro-active reorganization schedule in which, for any current object OR to be reorganized extracted from the list SELECT/OR in increasing priority order to promote the processing in advance of any objects of larger sizes, there is calculated for each reorganization region the last time DDRR of the region, representing in the “Batch” window allocated to “offline” reorganization the minimum time necessary for reorganizing the current object OR, equal in the present instance to the time consumed DCRR plus the time DROR to reorganize the current object;
(23)—Identifying the processing region RTR of the current object OR by optimized matching of the processing time DRR available in said region with the processing time DROR necessary for reorganizing the object POR with minimum DRR−DDRR<0;
(24)—Entering the current object OR as the next object to be reorganized POR in the schedule of the identified region by setting the pointer POR corresponding to the address of the current object OR and increasing the consumed time DCRR in the region by the reorganization time DROR;
(30)—Launching the reorganization of the object POR as soon as the identified reorganization processing region RTR is released in the absence of any event RAZR=1 occurring in the meantime; resetting and re-execution of the process IDPOR.

2. Method according to claim 1, wherein the optimum reorganization order is coordinated with the order of back-up copying of objects of the information system taking account of reorganizations in progress or just effected.

3. Method according to claim 2, wherein the back-up copying order is modified by executing with the highest priority, for at least one object OR to be reorganized, the copying of said object OR as soon as possible at the end of reorganization processing.

4. Method according to claim 1 of managing reorganizations of a set of indexed databases of an information system adapted to “offline” reorganization in at least one reorganization processing region, wherein the method integrates the organization of copying in at least one copying processing region and comprises the following operational phases:
(40)—Creating and maintaining by continuously updating:
a list PRIOREORG of objects to be reorganized in decreasing priority order as a function of the level of disorganization of the objects to be reorganized; and
a list PRIOCOPIE of objects to be copied in decreasing priority order as a function of the age of the last copies of the objects to be copied;
(50)—Continuously monitoring the occurrence in the information system of any event:
RAZR=1 for which the selection of the first or next object to be reorganized POR must be reviewed, in particular a reorganization task ending in a reorganization processing region and/or the release of a processing area for reorganization or copying; and/or
RAZC=1 for which the selection of the first or next object to copy POC must be reviewed, in particular at the end of a copying task in a copying processing region, priority copying at the end of reorganization and/or the release of a processing area for reorganization or copying, with for any event RAZR=1, launching the execution of the process IDPOR of identifying the first object to be reorganized POR or, if the process IDPOR is being executed, interrupting and relaunching the process IDPOR; and/or for an event RAZC=1, launching execution of the process IDPOC of identifying the first object to be copied POC or, if the process IDPOC is being executed, interrupting and relaunching the process IDPOC;
the process 1DPOR comprising the following operations:
(51)—Establishing a rapid reorganization schedule PRR* with the aid of the list PRIOREORG and the remaining reorganization operational time TRR available in all of the reorganization regions and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
(52)—Establishing a rapid copying schedule PRC from the list SELECT/OR, and then establishing, from the list PRIOCOPIE and within the limit of the remaining copying operational time TRC available in all of the copying regions, a selection list SELECT/OC in LIFO or stack memory for objects OC to be copied stacked in decreasing priority order;
(53′)—Setting up a retro-active copying schedule in which, for any current object to be reorganized extracted from the list SELECT/OR in increasing priority order, the time TCR to be reserved for copying the object OR after reorganization is calculated for each copying region;
(54)—Setting up a retro-active reorganization schedule in which, for any current object OR to be reorganized extracted from the list SELECT/OR in increasing priority order to promote the processing in advance of objects of the greatest possible sizes, the last time DDR of the region is calculated for each reorganization region, representing in the “Batch” window allocated to “offline” reorganization the minimum time necessary for reorganizing the object OR, in accordance with a different formulation according to whether a copy of the object OR being reorganized must be made or not;
(55)—Identifying the processing region RTR of the current object OR by optimized matching of the processing time DRR available in said region with the processing time DROR necessary for reorganizing the current object OR with minimum DRR−DDL<0 if no copying is to be done or with minimum absolute value of DRR−DDL and DROR+DOOR 5 DRR if copying is to be done;
(56)—Entering the current object OR as the next object to be reorganized POR in the schedule of the region identified by setting the pointer POR corresponding to the address of the object OR, increasing the consumed time DCRR in the region by the reorganization time DROR and recalculating the time DGRR wasted in the reorganization region because of copying the objects OR at the end of reorganization;
(60′)—Launching the reorganization of the object POR immediately an identified reorganization processing region RTR is available and if there is no reset event RAZR=1 in the meantime; resetting and re-executing the process IDPOR; and
the process IDPOC comprising the following operations:
(51)—Establishing a rapid reorganization schedule PRR* with the aid of the list PRIOREORG and the remaining reorganization operational time TRR available and a selection list SELECT/OR of objects OR to be reorganized in decreasing priority order optimized as a function of the benefit from the reorganization of each object OR, said benefit being defined as the product of a factor representative of the level of disorganization of an object OR by the time to reorganize that object;
(52)—Establishing a rapid copying schedule PRC from the list SELECT/OR, and then establishing, from the list PRIOCOPIE and within the limit of the remaining copying operational time TRC available in all the copying regions, a selection list SELECT/OC SELECT/OR in LIFO or stack memory for objects OC to be copied stacked in decreasing priority order;
(53)—Establishing a retro-active copying schedule with determination of the available copying times in the copying region, unsticking of the list SELECT/OC from top to bottom and searching for a copying region by matching the available copying time and the copying time of the current object OC to be copied so as to copy the largest possible objects, and marking the source of the reorganization or non-reorganization of the object to be copied; followed by
identifying the processing region RTC of the object to be copied by matching the processing time available in said region with the processing time necessary for copying the current object OC; followed by
entering the current object OC as the next object to be copied POC in the schedule of the identified region RTC by setting the pointer POC corresponding to the address of the object OC and reducing the available processing time by the time to copy the object OC retained as POC;
(60)—Launching the copying of the object POC immediately a copying processing region TRC identified is available and if there is no reset event RAZC=1 in the meantime; resetting and re-executing the process IDPOC.

5. Method according to claim 4, integrating into the final phases of the process IDPOR for an object OR a phase of searching for one or more objects OR to be reorganized without copying OR in the list SELECT/OR or by default in the list PRIOREORG liable to be reorganized in the corresponding processing region RTR during the time waiting for copying of the object OR after reorganization.

6. Method according to claim 4, wherein said phase (51) of establishing a rapid reorganization schedule PRR* comprises the following operations:
(511)—Initialization: wherein the selection indicators of the objects OR are eliminated and the review counter-limiter, the remaining copying time TRC, the remaining reorganization time TRR and the minimum time E for reorganizing and copying an object OR are initialized;
(512)—Loop on objects: wherein a ‘selection possible’ mark is applied for any real object OR from the list PRIOREORG processed in decreasing order until TRR<E;
(513)—Eliminating intersections of objects: real objects OR from table spaces also known as global objects already selected in whole or in part are eliminated from the ‘selection possible’ mark;
(514)—Reviewing preceding choices: wherein objects OR whose total reorganization and copying time is greater than the remaining reorganization time TRR are eliminated from the ‘selection possible’ mark, and by default the current object OR and the objects OR already selected in the list SELECT/OR are subjected to a process of optimization as a function of the reorganization benefit with replacement of an object already selected by the current object with tests, within the limit of the term of the counter-limiter, of successive combinations tending to retain to be finally selected in the SELECT/OR list of objects with the greatest possible reorganization benefit and associating them with the other objects OR of the ‘possible selection’ mark so that the total time for reorganizing all of the objects OR retained is less than but as close as possible to the remaining reorganization time TRR;
(515)—Verifying the sufficiency of the available copying time in the remaining copying time TRC for each object OR currently being finally selected for reorganization, taking account of the reorganization priority of the object OR relative to objects to be copied before it because of their higher copying priorities;
(516)—Selecting the current object OR in the list SELECT/OR: wherein the indicators of the current object OR and of the associated global object are set, where applicable the indicators of the deselected object or objects OR are eliminated, and TRR and TRC are decreased by the reorganization and copying times, respectively.

7. Method according to claims 4 wherein said phase (52) of establishing a rapid copying schedule PRC comprises the following operations:
(521)—Initialization: wherein on exiting a reorganization schedule PRR* the copy selection stacks PSC1 and PSC2 are emptied and the review counter-limiter, the remaining copying time TRC and the minimum time EC to copy an object OC to be copied are initialized;
(522)—Inspecting reorganization regions: wherein for all the regions, if the region is active, and if image copying of the object being reorganized is to be done and/or if image copying of any object OR from the list SELECT/OR taken in decreasing priority order is to be done: for any sub-object liable to be copied separately, in particular a partition, the copying time of the sub-object of TRC is
subtracted and the sub-object is placed at the top of the first stack PSC1;
(523)—Processing the list PRIOCOPIE of objects to be copied: for any object OC to be copied from the list PRIOCOPIE taken in decreasing order until TRC<EC and absent from PSC1, the copying time of the sub-object OC is subtracted from TRC and the sub-object OC is placed at the top of the second stack PSC2,
(524)—Stacking selection stacks: the stack PSC1 is placed on top of the stack PSC2 to constitute the list SELECT/OC.

8. Method according to claim 7 wherein said phase (53) of establishing a retro-active copying schedule in the process IDPOR comprises the following operations:
(531) Initializing the copying regions: wherein on exiting a reorganization schedule for all the copying regions, the consumed time DCRC of the region is set to zero;
(532) Determining the copying time TCR to be reserved: wherein for any real object from the list SELECT/OR scanned in increasing priority order and then taken as the current object OR to be reorganized:
the time TCR to be reserved for copying the current real object OR is set to zero;
if image copying of any object OR from the list SELECT/OR in increasing priority order is to be done: for any sub-object liable to be copied separately, in particular partition, a search is made for a copying region whose consumed time DCRC is minimal, the copying time of the sub-object is added to the consumed time DCRC of the current region and the time TCR to be reserved for copying the current object (=maximum of the time TOR to be reserved for copying the current object and the consumed time DCRC in the region) is set.

9. Method according to claim 8, wherein retro-active reorganization scheduling phase (54) in the process IDPOR comprises the following operations:
(541)—Initialization: wherein for any reorganization region:
Time DRR of the region=Time DFB of the ‘Batch’ window less the estimated relative time HRFR of the end of reorganization processing in progress in the region
Time consumed in the region DCRR=0
Time wasted in the region DGRR=0
Pointer to the first object to reorganize in the current region=0 (542)—Determining the last time DDRR of the reorganization region: wherein for any real object OR selected from the list SELECT/OR in increasing priority order: For each region, if image copying of the current object OR is to be done, calculating the last time of the region DDRR=reorganization time DROR of the current object+maximum of the time TCR to be reserved for copying the current object and the total consumed time DCRR of the region+the wasted time DGRR of the region;
if not, calculating the last time DDR of the region=consumed time DCRR of the region+maximum of the reorganization time DROR of the current object and the wasted time DGRR of the region.

10. Method according to claim 9, wherein said phase of identifying the reorganization region RTR (55) comprises the following operations:
According to the type of current object OR to be reorganized:
(551)—Searching for the reorganization processing region liable to accommodate optimally an object OR to be reorganized without copying, comprising:
searching for a region whose last time DDRR is minimal, and if the last time DDR of the current region is greater than the time DRR of the current region, searching for a region for which the time DRR of the current region minus the last time DDRR of the current region is minimal and positive or zero; if not
(552)—Searching for the reorganization region liable to accommodate optimally an object OR to be reorganized with copying, comprising:
Searching for a region such that the absolute value of the time DRR of the region minus the last time DDRR of the current region is minimal and the reorganization time DROR plus the time TCR to copy the current object is less than or equal to the time DRR of the region.

11. Method according to claim 10, wherein said phase of writing the object OR into the schedule of the reorganization region RTR (56) comprises the following operations:
(561)—Writing the object OR as the next object to be reorganized POR: if image copying of the current object is to be done or the wasted time of the current region is equal to zero, the first object to be reorganized pointer POR of the current region is set to the address of the current object OR,
(562)—Updating DCRR and DGRR: wherein the reorganization time DROC of the current object is added to the consumed time DCRR of the current region and the wasted time DGRR of the current region is set to the last time DDRR of the current region minus the consumed time DCRR of the current region.

12. Method according to claim 4 wherein said phase (53′) of establishing a retro-active copying schedule in the process IDPOC comprises the following operations:
(531′)—Initializing the copying regions: wherein for all regions: the region time DROOP is set to the “Batch” window time DFB less the estimated relative time HRFC of the end of the current copying processing,
the consumed time DCRCOP of the region is set to zero,
the pointer POC of the first object to be copied of the current region is set to zero,
(532′) Unstacking and identifying the next object to be copied POC: wherein for any object from the stack PSC1/PSC2 scanned from top to bottom a current object OC to be copied is extracted when the copying time TCOC of the current object is less than or equal to the longest DRCOP;
To identify the copying processing region, searching for a region whose consumed time DCRCOP is minimal; in the event of a result in the affirmative, if the copying time TCOC of the current object is greater than DROOP minus DCRCOP a region is searched for in which DRCROP minus DCRCOP minus TCOC is minimal, positive or zero,
If no region is suitable, a region to copy is chosen for which the absolute value of DRCOP minus DCRCOP minus TCOC is negative and minimal and for which TCOC is less than or equal to DROOP;
If the current object belongs to the second stack PSC2, i.e. an object to be copied that does not result from a reorganization, the pointer POC of the object for the chosen current region is set to the address of the current object OC to write the object P00 into the schedule of the identified copying processing region RTC; and To terminate, the copying time TCOC is added to the consumed time DCRCOP of the current region.

13. Method according to claim 4, wherein said events RAZR=1 and RARC=1 internal to the system leading to reviewing the selection of the objects POR or POC are respectively the end of a reorganization task in a reorganization processing region for the objects POR or the end of a copying task in a copying processing region for the objects POC, priority copying at the end of reorganization, and/or releasing of a processing area for the objects POR and POC.

14. Method according to claim 1 for managing reorganization of a set of indexed databases of an information data processing system adapted to the “online” reorganization and intended to operate in association with a management method according to any preceding claim, characterized in that it comprises at least the following operational phases:
a phase of instantaneous analysis of at least one object OR to be reorganized from among the objects liable to be reorganized, in particular databases, partitions and/or indexes to be reorganized, and estimation of the overcost associated with the level of disorganization of the object OR to be reorganized;
a phase of instantaneous estimation of the cost of online reorganization as a function of the size of said object OR to be reorganized and of the level of disorganization of said object OR to be reorganized; and
a phase of determination of the minimum disorganization threshold Ds of the object OR to be reorganized above which threshold “online” reorganization may be launched for that object OR and where applicable the effective launching of that online reorganization, the threshold Ds corresponding substantially to the minimum of the total of the estimated overcost of disorganization and the estimated cost of reorganization for the object OR concerned.

15. Method according to claim 14 wherein launching “online” reorganization is delayed pending a time window of reduced activity of the database concerned.

16. Method according to claim 14 for managing “online” and “offline” reorganization, wherein for an object OR to be reorganized selected as the first object POR to be reorganized priority is given to “Offline” reorganization, “online” reorganization being required only after the threshold Ds is crossed for the object POR concerned.

17. Method according to claims 14 for use for the reorganization of indexed table space databases, wherein for an object OR to be reorganized, the threshold Ds is defined, when U the hourly mean number of updates to the object OR is low, by an approximation given by the following formula F5′:
R=DsI²rCo*/2.I.c=1
in which:
r designates the mean number of rows or key-RID per page of the entire object, I designates the number of row or key-RID insertions for the indexes at the time in the object OR, Co* designates the hourly overcost when the object is totally disorganized, and c designates a machine parameter, the ratio of the access time E/S to the size Nbp of the object.

18. Method according to claim 17 for use for the reorganization of indexes, wherein, for an index, the threshold Ds=DsI is defined, when U the hourly mean number of updates to the index is low, by an approximation given by the following formula F7′:
R=DsI²r(t*+1)Nbp.V/[2(V+3)]=1
in which:
V=Ts/TI,
Ts designates the arm displacement time, TI designates the latency time (½ arm turn), c=(Ts+3.TI)/Nbp, and t* designates the rate of rereading of the object, corresponding to the mean number of times that an entry will be reread.

19. Method according to claim 17 for use for the reorganization of indexed monotable space databases with n indexes, wherein the threshold Ds=DsT is defined for a monotable space, when U, the hourly mean number of updates to the monotable space, is low, by an approximation given by the following formula F13′:
R=r.Nbp[DsT².L(V+1)+V.S(DsT²−bi²)(t*i+1)]/(2V+6)=1
in which:
L designates the proportion of rows accessed per sequential scan to the number of rows created, S represents the mathematical symbol Σ, denoting the sum of the expressions f(xi) for values of the index i from 1 to n, bi represents the instantaneous values of the disorganisation factor D of the monotable space, at the time of the last reorganizations of the n indexes, and t*i represents the rate of direct access via each index i.

20. Method according to claim 1 for used for managing reorganization of indexed table space databases.

21. Method according to claim 1 used within a date processing system comprising hardware and software means adapted for “offline” reorganization of indexed table space databases.

22. Method of managing reorganization of a set of indexed databases of an information data processing system adapted to the “online” reorganization comprising at least the following operational phases:
a phase of instantaneous analysis of at least one object OR to be reorganized from among the objects liable to be reorganized, in particular databases, partitions and/or indexes to be reorganized, and estimation of the overcost associated with the level of disorganization of the object OR to be reorganized;
a phase of instantaneous estimation of the cost of “online” reorganization as a function of the size of said object OR to be reorganized and of the level of disorganization of said object OR to be reorganized; and
a phase of determination of the minimum disorganization threshold Ds of the object OR to be reorganized above which threshold “online” reorganization may be launched for that object OR and where applicable the effective launching of that “online” reorganization, the threshold Ds corresponding substantially to the minimum of the total of the estimated overcost of disorganization and the estimated cost of reorganization for the object OR concerned.

23. Method according to claim 22 for use for the reorganization of indexed table space databases, wherein for an object OR to be reorganized, the threshold Ds is defined, when U the hourly mean number of updates to the object OR is low, by an approximation given by the following formula F5′:
R=Ds²rCo*/2.I.c=1
in which:
r designates the mean number of rows or key-RID per page of the entire object, I designates the number of raw or key-RID insertions for the indexes at the time in the object OR, Co* designates the hourly overcost when the object is totally disorganized, and c designates a machine parameter, the ratio of the access time E/S to the size Nbp of the object.

24. Method according to claim 23 for use for the reorganization of indexes, wherein, for an index, the threshold Ds=DsI is defined, when U the hourly mean number of updates to the index is low, by an approximation given by the following formula F7′:
R=Ds/²r(t*+1)Nbp.V/[2(V+3)]=1 in which:
V=Ts/TI, Ts designates the arm displacement time, Tl designates the latency time (½ arm turn), c=(Ts+3.TI)/Nbp, and
t* designates the rate of rereading of the object corresponding to the mean number of times that an entry will be reread.

25. Method according to claim 23 for use for the reorganization of indexed monotable space databases with n indexes, wherein the threshold Ds=DsT is defined for a monotable space, when U, the hourly mean number of updates to the monotable space, is low, by an approximation given by the following formula F13′:
R=r.Nbp[DsT².L(V+1)+V.S(DsT²−bi²)(t*i+1)]/(2V+6)=1
in which:
L designates the proportion of rows accessed per sequential scan to the number of rows created, S represents the mathematical symbol Σ, denoting the sum of the expressions f(xi) for values of the index i from 1 to n, bi represents the instantaneous values of the disorganisation factor D of the monotable space, at the time of the last reorganizations of the n indexes, and t*i represents the rate of direct access via each index i.
